(19) United States
(12) Patent Application Publication
(10) Pub. No.: US 2023/0295818 A1
(43) Pub. Date: Sep. 21, 2023

(54) AMMONIA PRODUCTION METHOD AND AMMONIA PRODUCTION APPARATUS

(71) Applicants: THE UNIVERSITY OF TOKYO, Tokyo (JP); NISSAN CHEMICAL CORPORATION, Tokyo (JP)

(72) Inventors: Yoshiaki NISHIBAYASHI, Tokyo (JP); Kazuya ARASHIBA, Tokyo (JP); Yuya ASHIDA, Tokyo (JP); Shoichi KONDO, Funabashi-shi (JP); Takamasa KIKUCHI, Funabashi-shi (JP)

(73) Assignees: THE UNIVERSITY OF TOKYO, Tokyo (JP); NISSAN CHEMICAL CORPORATION, Tokyo (JP)

(21) Appl. No.: 18/021,336

(22) PCT Filed: Aug. 16, 2021
(86) PCT No.: PCT/JP2021/029955

§ 371 Date: Feb. 14, 2023

(30) Foreign Application Priority Data
Aug. 14, 2020 (JP) 2020-137147
Nov. 10, 2020 (JP) 2020-187630

(51) Int. Cl. C25B 11/095; C01C 1/04; C25B 1/27; C25B 9/23; C25B 11/032

(52) U.S. Cl. CPC C25B 11/095; C01C 1/0494; C25B 1/27; C25B 9/23; C25B 11/032

(57) ABSTRACT

A method for producing ammonia involves producing ammonia from molecular nitrogen in a production apparatus for performing electrolysis by supplying electrons from a power source, protons from a proton source and molecular nitrogen from a device for supplying a nitrogen gas while in the presence of a solid catalyst and a complex in a cathode. For example, a molybdenum complex represented by formula (A1) or formula (B2) as the complex, and a platinum catalyst or a platinum catalyst/gold catalyst combination as the solid catalyst are used.

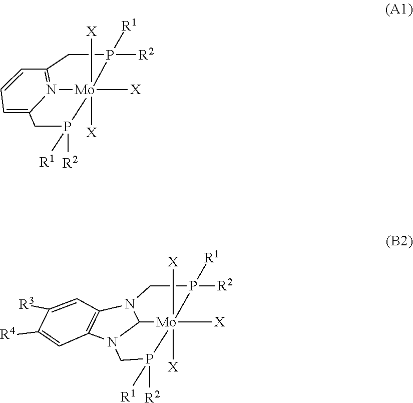

### TECHNICAL FIELD

The present invention relates to an ammonia production method and an ammonia production apparatus.

### BACKGROUND ART

There has been reported a method of electrolytically producing ammonia from nitrogen molecules in a low temperature range, wherein ammonia is produced by electrolysis at 90° C. with use of a cathode formed of a carbon felt and ruthenium supported thereon, and a platinum electrode serving as an anode (Non-Patent Document 1). There has been a report on the production of ammonia by electrolysis with use of an electrode containing, for example, Sm_{1.5}Sr_{0.1}CoO₄ at which ammonia is produced (Non-Patent Document 2).

Meanwhile, there has been a report on the reaction of producing ammonia from nitrogen molecules, wherein a molybdenum complex is used in a catalyst, samarium(II) iodide is used as a reducing agent, and an alcohol or water is used as a proton source (Non-Patent Document 3). There has been a report on the production of ammonia with use of a molybdenum complex supported on a polystyrene resin (Non-Patent Document 4).

### PRIOR ART DOCUMENTS

### Non-Patent Documents

Non-Patent Document 1: Chem. Commun. 2000, pp. 1673-1674
Non-Patent Document 2: Sci. Rep. 2013, Vol. 3, pp. 1145-1151
Non-Patent Document 3: Nature, 2019, Vol. 568, pp. 536-540
Non-Patent Document 4: Chem. Lett. 2019, Vol. 48, pp. 693-695 SUMMARY OF THE INVENTION

### Problems to be Solved by the Invention

The technique described in Non-Patent Document 1 has a problem in terms of operation at about 20 to 30° C. (i.e., room temperature), since electrolysis is performed in a low temperature range (about 90 to 100° C.). The technique described in Non-Patent Document 2 has a problem in that the operation is not easy from the viewpoint of reusing an electrolyzer, due to a cumbersome process of treating a Nafion membrane (serving as an electrolyte membrane) with ammonia before incorporation of the membrane into the electrolyzer.

The technique described in Non-Patent Document 3 requires the use of samarium(II) iodide as a reducing agent, and the technique described in Non-Patent Document 4 requires the use of decamethylcobaltocene as a reducing agent. These techniques have a problem in terms of practical use, since the recovery and recycle of such a reducing agent are not easy.

In order to solve the aforementioned problems, a main object of the present invention is to provide a method for electrochemically producing ammonia, wherein a reducing agent is not used, the pretreatment of an electrolyte membrane is avoided, and the operation is performed at about 20 to 30° C. (i.e., room temperature).

### Means for Solving the Problems

In order to achieve the aforementioned object, the present inventors have found that ammonia can be electrochemically produced by using a complex such as a molybdenum complex in combination with a solid catalyst such as a metal catalyst or an oxide catalyst. The present invention has been accomplished on the basis of this finding. Non-Patent Documents 1 and 2 are reports on electrochemical ammonia production using a solid catalyst. Thus, there has not yet been a report on electrochemical ammonia production using a membrane electrode assembly or gas diffusion electrode prepared from a combination of a complex and a solid catalyst.

The present invention based on the aforementioned finding provides, for example, the following.

[1] An ammonia production method comprising supplying electrons from a power source, protons from a proton source, and nitrogen molecules from nitrogen gas supply means in the presence of a complex and a solid catalyst at a cathode in a production apparatus performing electrolysis, thereby producing ammonia from nitrogen molecules, wherein the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); the solid catalyst is a metal catalyst, an oxide catalyst, or a combination of these; and the proton source is an electrolyte membrane, an electrolytic solution, or both the electrolyte membrane and the electrolytic solution.

[2] The ammonia production method according to [1], wherein the molybdenum complex (A) is a molybdenum complex of the following Formula (A1), (A2), or (A3):

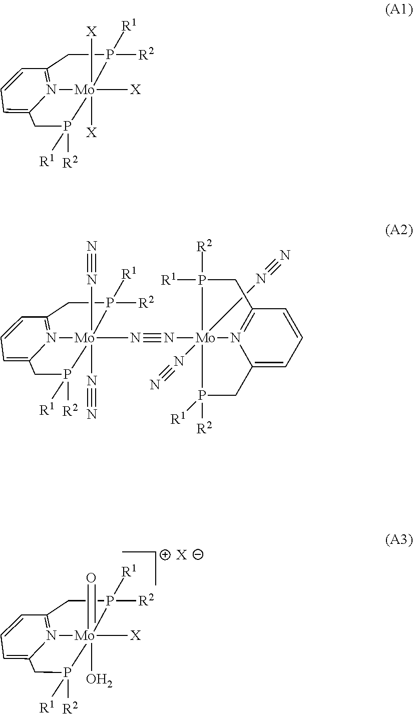

(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

[3] The ammonia production method according to [1], wherein the molybdenum complex (B) is a molybdenum complex of the following Formula (B1) or (B2):

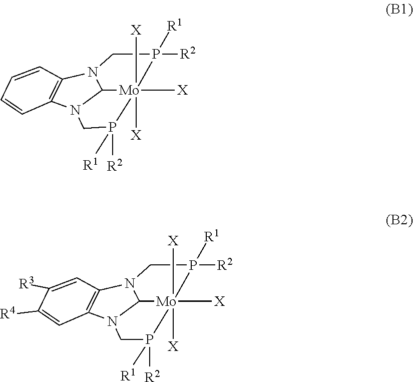

(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

[4] The ammonia production method according to [1], wherein the molybdenum complex (C) is a molybdenum complex of the following Formula (C1):

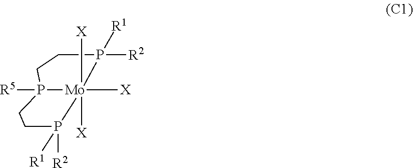

(wherein R¹ and R² are alkyl groups that are possibly identical to or different from each other; R⁵ is an aryl group; and X is an iodine atom, a bromine atom, or a chlorine atom).

[5] The ammonia production method according to [1], wherein the molybdenum complex (D) is a molybdenum complex of the following Formula (D1) or (D2):

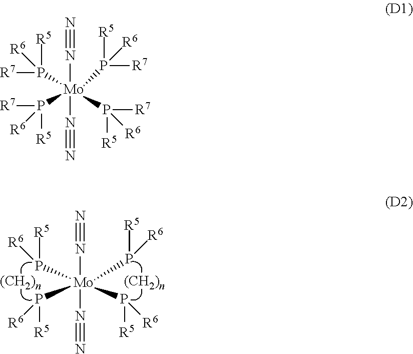

(wherein R⁵ and R⁶ are aryl groups that are possibly identical to or different from each other; R⁷ is an alkyl group; and n is 2 or 3).

[6] The ammonia production method according to any of [1] to [5], wherein the solid catalyst contains platinum, gold, palladium, or zinc oxide.

[7] A membrane electrode assembly comprising a cathode catalyst layer, an anode catalyst layer, and an electrolyte membrane sandwiched between the layers and bonded thereto, wherein
the cathode catalyst layer contains a complex and a cathode solid catalyst;
the anode catalyst layer contains an anode solid catalyst;
the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); and
each of the cathode solid catalyst and the anode solid catalyst is a metal catalyst, an oxide catalyst, or a combination of these.

[8] The membrane electrode assembly according to [7], wherein the molybdenum complex (A) is a molybdenum complex of the following Formula (A1), (A2), or (A3):

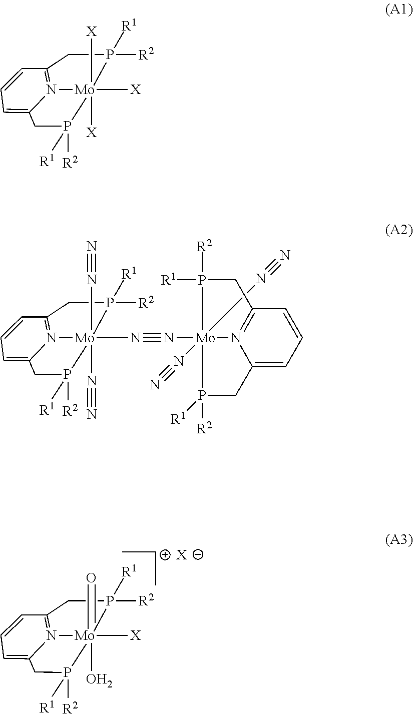

(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

[9] The membrane electrode assembly according to [7], wherein the molybdenum complex (B) is a molybdenum complex of the following Formula (B1) or (B2):

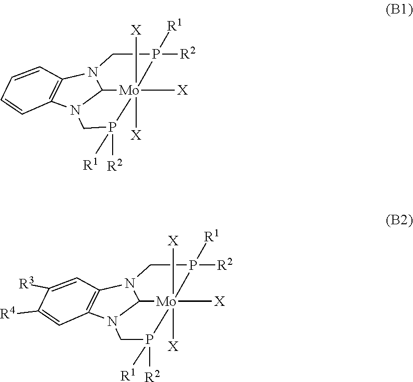

(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

[10] The membrane electrode assembly according to [7], wherein the molybdenum complex (C) is a molybdenum complex of the following Formula (C1):

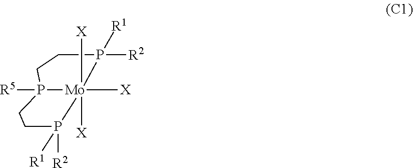

(wherein R¹ and R² are alkyl groups that are possibly identical to or different from each other; R⁵ is an aryl group; and X is an iodine atom, a bromine atom, or a chlorine atom).

[11] The membrane electrode assembly according to [7], wherein the molybdenum complex (D) is a molybdenum complex of the following Formula (D1) or (D2):

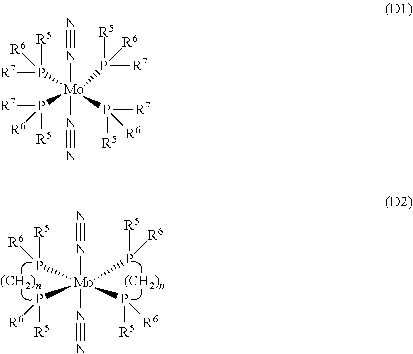

(wherein R⁵ and R⁶ are aryl groups that are possibly identical to or different from each other; R⁷ is an alkyl group, and n is 2 or 3).

[12] The membrane electrode assembly according to any of [7] to [11], wherein the cathode solid catalyst contains platinum, gold, palladium, or zinc oxide.

[13] An ammonia production apparatus for producing ammonia from nitrogen molecules by electrolysis, the apparatus comprising the membrane electrode assembly according to any of [7] to [12] comprising a cathode catalyst layer, an electrolyte membrane, and an anode catalyst layer; a cathode including the cathode catalyst layer bonded to one side of the electrolyte membrane, and a cathode collector disposed outside of the cathode catalyst layer; and an anode including the anode catalyst layer bonded to the other side of the electrolyte membrane, and an anode collector disposed outside of the anode catalyst layer, wherein
the cathode includes the cathode catalyst layer and the cathode collector;
the anode includes the anode catalyst layer and the anode collector;
the apparatus comprises a bath of a cathode electrolytic solution which is in liquid contact with the cathode, a bath of an anode electrolytic solution which is in liquid contact with the anode, a power source for supplying electrons to the cathode, a proton source for supplying protons to the cathode, and means for supplying nitrogen gas to the cathode electrolytic solution or the cathode; and
the proton source is the electrolyte membrane, the anode electrolytic solution, or both the electrolyte membrane and the anode electrolytic solution.

[14] An ammonia production apparatus for producing ammonia from nitrogen molecules by electrolysis, the apparatus comprising the membrane electrode assembly according to any of [7] to [12] comprising a cathode catalyst layer, an electrolyte membrane, and an anode catalyst layer; a cathode including the cathode catalyst layer bonded to one side of the electrolyte membrane, and a cathode collector disposed outside of the cathode catalyst layer; and an anode including the anode catalyst layer bonded to the other side of the electrolyte membrane, and an anode collector disposed outside of the anode catalyst layer, wherein
the cathode includes the cathode catalyst layer and the cathode collector;
the anode includes the anode catalyst layer and the anode collector;
the apparatus comprises an anode electrolytic solution bath containing an anode electrolytic solution which is in liquid contact with the anode of the membrane electrode assembly, a power source for supplying electrons to the cathode, a proton source for supplying protons to the cathode, and means for supplying nitrogen gas to the cathode; and
the proton source is the electrolyte membrane, the electrolytic solution, or both the electrolyte membrane and the electrolytic solution.

[15] A gas diffusion electrode comprising a complex and a cathode solid catalyst, wherein the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); and
the cathode solid catalyst is a metal catalyst, an oxide catalyst, or a combination of these.

[16] The gas diffusion electrode according to [15], wherein the molybdenum complex (A) is a molybdenum complex of the following Formula (A1), (A2), or (A3):

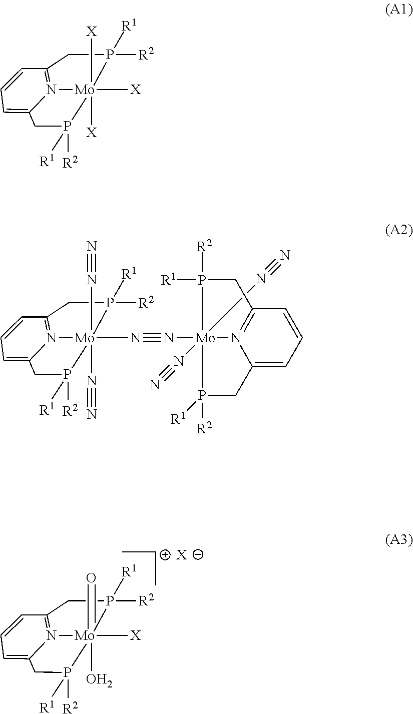

(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

[17] The gas diffusion electrode according to [15], wherein the molybdenum complex (B) is a molybdenum complex of the following Formula (B1) or (B2):

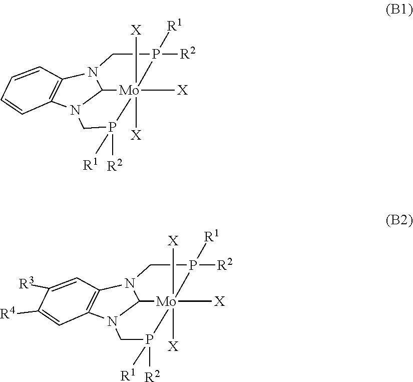

(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R; and R⁴ is substituted with a trifluoromethyl group).

[18] The gas diffusion electrode according to [15], wherein the molybdenum complex (C) is a molybdenum complex of the following Formula (C1):

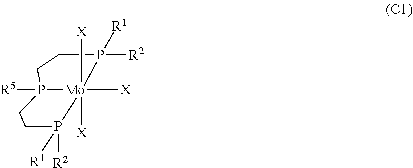

(wherein R¹ and R² are alkyl groups that are possibly identical to or different from each other; R⁵ is an aryl group; and X is an iodine atom, a bromine atom, or a chlorine atom).

[19] The gas diffusion electrode according to [15], wherein the molybdenum complex (D) is a molybdenum complex of the following Formula (D1) or (D2):

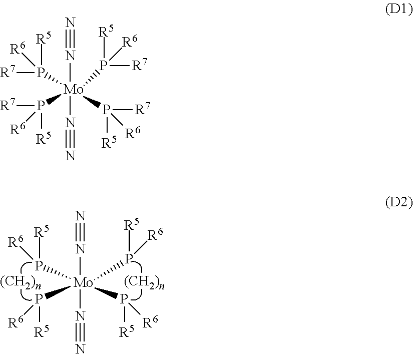

(wherein R⁵ and R⁶ are aryl groups that are possibly identical to or different from each other; R⁷ is an alkyl group; and n is 2 or 3).

[20] The gas diffusion electrode according to any of [15] to [19], wherein the cathode solid catalyst contains platinum, gold, palladium, or zinc oxide.

[21] An ammonia production apparatus for producing ammonia from nitrogen molecules by electrolysis, the apparatus comprising the gas diffusion electrode according to any of [15] to [20], the gas diffusion electrode being a cathode catalyst layer;
a cathode collector disposed on one side of the cathode catalyst layer being the gas diffusion electrode;
a bath of an electrolytic solution which is in liquid contact with the cathode catalyst layer;
a cathode including the cathode catalyst layer and the cathode collector;
an anode formed of a metal plate electrode;
a power source for supplying electrons to the cathode;
a proton source for supplying protons to the cathode; and
means for supplying nitrogen gas to the electrolytic solution or the cathode, wherein the proton source is the electrolytic solution.

[22] A cathode membrane electrode assembly comprising an electrolyte membrane and a cathode catalyst layer bonded to one side of the electrolyte membrane, wherein the cathode catalyst layer contains a complex and a cathode solid catalyst;
the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); and
the cathode solid catalyst is a metal catalyst, an oxide catalyst, or a combination of these.

[23] The cathode membrane electrode assembly according to [22], wherein the molybdenum complex (A) is a molybdenum complex of the following Formula (A1), (A2), or (A3):

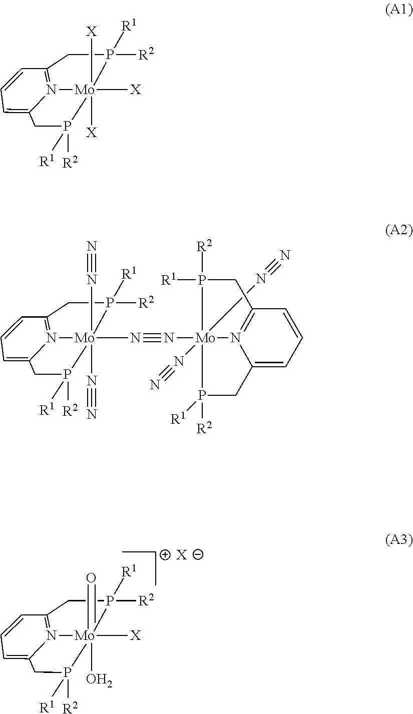

(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

[24] The cathode membrane electrode assembly according to [22], wherein the molybdenum complex (B) is a molybdenum complex of the following Formula (B1) or (B2):

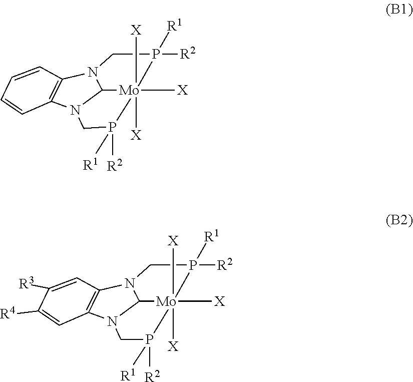

(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

[25] The cathode membrane electrode assembly according to [22], wherein the molybdenum complex (C) is a molybdenum complex of the following Formula (C1):

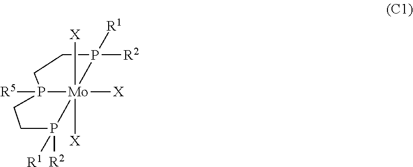

(wherein R¹ and R² are alkyl groups that are possibly identical to or different from each other; R⁵ is an aryl group; and X is an iodine atom, a bromine atom, or a chlorine atom).

[26] The cathode membrane electrode assembly according to [22], wherein the molybdenum complex (D) is a molybdenum complex of the following Formula (D1) or (D2):

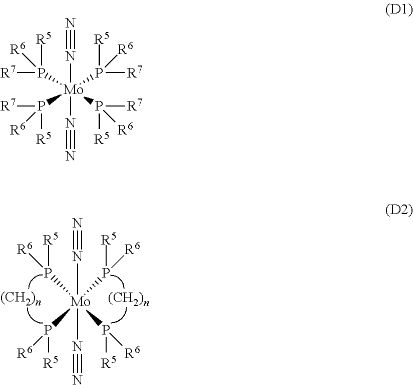

(wherein R⁵ and R⁶ are aryl groups that are possibly identical to or different from each other; R⁷ is an alkyl group; and n is 2 or 3).

[27] The cathode membrane electrode assembly according to any of [22] to [26], wherein the cathode solid catalyst contains platinum, gold, palladium, or zinc oxide.

[28] An ammonia production apparatus for producing ammonia from nitrogen molecules by electrolysis, the apparatus comprising the cathode membrane electrode assembly according to any of [22] to [27] comprising an electrolyte membrane and a cathode catalyst layer bonded to one side of the electrolyte membrane;
a cathode collector disposed on a side of the cathode catalyst layer opposite the electrolyte membrane;
a cathode including the cathode catalyst layer and the cathode collector;
a bath of an electrolytic solution which is in liquid contact with the electrolyte membrane;
an anode formed of a metal plate electrode,
a power source for supplying electrons to the cathode;
a proton source for supplying protons to the cathode; and
means for supplying nitrogen gas to the electrolytic solution or the cathode, wherein the proton source is the electrolyte membrane, the electrolytic solution, or both the electrolyte membrane and the electrolytic solution.

### Effects of the Invention

According to the ammonia production method of the present invention, ammonia can be produced from nitrogen molecules by supplying electrons from a power source, protons from a proton source, and nitrogen molecules from nitrogen gas supply means in the presence of a complex and a solid catalyst at a cathode in a production apparatus performing electrolysis.

### BRIEF DESCRIPTION OF THE DRAWINGS

FIG. 1 is an explanatory view of an ammonia electrolyzer (No. 1).

FIG. 2 is an explanatory view of an ammonia electrolyzer (No. 2).

FIG. 3 is an explanatory view of an ammonia electrolyzer (No. 3).

FIG. 4 is an explanatory view of an ammonia electrolyzer (No. 4).

### MODES FOR CARRYING OUT THE INVENTION

Next will be described a preferred embodiment of the ammonia production method and production apparatus of the present invention.

As used herein, “n” denotes normal; “s” denotes secondary; “t” denotes tertiary; “o” denotes ortho; “m” denotes meta; and “p” denotes para.

The term “Cₐ to C_{b} alkyl group” as used herein refers to a monovalent group prepared by removal of one hydrogen atom from a linear, branched, or cyclic aliphatic hydrocarbon having a carbon atom number of a to b. Specific examples of the alkyl group include methyl group, ethyl group, n-propyl group, isopropyl group, cyclopropyl group, n-butyl group, isobutyl group, s-butyl group, t-butyl group, cyclobutyl group, n-pentyl group, isopentyl group, neopentyl group, t-pentyl group, 1,1-dimethylpropyl group, cyclopentyl group, n-hexyl group, isohexyl group, 3-methylpentyl group, 2,2-dimethylbutyl group, 2,3-dimethylbutyl group, cyclohexyl group, n-heptyl group, 2-methylhexyl group, 3-ethylpentyl group, n-octyl group, 2,2,4-trimethylpentyl group, 2,5-dimethylhexyl group, n-nonyl group, 2,7-dimethyloctyl group, and n-decyl group, which are determined within a specified carbon atom number range. In the “Cₐ to C_{b}” corresponding to the number of carbon atoms, a is an integer of 1 or more, and b is an integer of a or more.

The term “Cₐ to C_{b} alkoxy group” as used herein refers to a monovalent group prepared by bonding of oxygen to the aforementioned alkyl group having a carbon atom number of a to b. Specific examples of the alkoxy group include methoxy group, ethoxy group, n-propoxy group, isopropoxy group, cyclopropoxy group, n-butoxy group, isobutoxy group, s-butoxy group, t-butoxy group, cyclobutoxy group, n-pentoxy group, isopentoxy group, neopentoxy group, t-pentoxy group, 1,1-dimethylpropoxy group, cyclopentoxy group, n-hexoxy group, isohexoxy group, 3-methylpentoxy group, 2,2-dimethylbutoxy group, 2,3-dimethylbutoxy group, cyclohexoxy group, n-heptoxy group, 2-methylhexoxy group, 3-ethylpentoxy group, n-octoxy group, 2,2,4-trimethylpentoxy group, and 2,5-dimethylhexoxy group, which are determined within a specified carbon atom number range.

Specific examples of the halogen atom as used herein include fluorine atom, chlorine atom, bromine atom, and iodine atom.

The term “Ar₆ aryl group” as used herein refers to a monovalent group prepared by removal of one hydrogen atom from the aromatic ring of an aromatic hydrocarbon having a carbon atom number of 6. Examples of the aryl group include a phenyl group and a phenyl group having a substituent on at least one of positions 2 to 6 thereof. Examples of the substituent on the aromatic ring of the Ar₆ aryl group include halogen atoms such as fluoro group, chloro group, bromo group, and iodo group, methyl group, trifluoromethyl group, ethyl group, n-propyl group, isopropyl group, n-butyl group, isobutyl group, s-butyl group, and t-butyl group. Specific examples of the Ar₆ aryl group include phenyl group, o-fluorophenyl group, m-fluorophenyl group, p-fluorophenyl group, o-trifluoromethylphenyl group, m-trifluoromethylphenyl group, p-trifluoromethylphenyl group, o-chlorophenyl group, m-chlorophenyl group, p-chlorophenyl group, o-bromophenyl group, m-bromophenyl group, p-bromophenyl group, o-tolyl group, m-tolyl group, p-tolyl group, o-ethylphenyl group, m-ethylphenyl group, p-ethylphenyl group, o-(t-butyl)phenyl group, m-(t-butyl)phenyl group, p-(t-butyl)phenyl group, 3,5-dimethylphenyl group, 3,5-bistrifluoromethylphenyl group, 3,4,5-trifluorophenyl group, o-methoxyphenyl group, m-methoxyphenyl group, and p-methoxyphenyl group.

The ammonia production method of the present embodiment can be performed with a production apparatus performing electrolysis. The production apparatus performing electrolysis, which may be referred to herein as “electrolyzer,” includes an electrolysis cell, nitrogen gas supply means, ammonia recovery means, and exhaust gas elimination means. Details of the electrolyzer will be described below. The electrolysis cell includes electrodes, an electrolytic solution bath, a nitrogen gas supply inlet, and an exhaust gas outlet. The electrodes include an anode; i.e., an electrode where oxidation reaction occurs, and a cathode; i.e., an electrode where reduction reaction occurs.

The ammonia production method of the present embodiment involves supplying electrons from a power source, protons from a proton source disposed in an electrolyzer, and nitrogen molecules from nitrogen gas supply means in the presence of a complex such as a molybdenum complex and a solid catalyst at a cathode, thereby producing ammonia from nitrogen molecules. This method involves the use of a catalyst for ammonia production in the form of a combination of a complex and a solid catalyst at the cathode. The combination of a complex and a solid catalyst may be referred to herein as “catalyst body.”

The complex used in the ammonia production method of the present embodiment is (A) a molybdenum complex having, as a PNP ligand, 2,6-bis(dialkylphosphinomethyl)pyridine (wherein the two alkyl groups may be identical to or different from each other, and at least one hydrogen atom of the pyridine ring may be substituted with an alkyl group, an alkoxy group, or a halogen atom); (B) a molybdenum complex having, as a PCP ligand, N,N-bis(dialkylphosphinomethyl)dihydrobenzimidazolidene (wherein the two alkyl groups may be identical to or different from each other, and at least one hydrogen atom of the benzene ring may be substituted with an alkyl group, an alkoxy group, or a halogen atom): (C) a molybdenum complex having, as a PPP ligand, bis(dialkylphosphinoethyl)arylphosphine (wherein the two alkyl groups may be identical to or different from each other); or (D) a molybdenum complex of trans-Mo(N₂)₂(R⁵R⁶R⁷P)₄ (wherein R⁵ and R⁶ are aryl groups that may be identical to or different from each other; R⁷ is an alkyl group; and two R⁷s may be connected together to form an alkylene chain).

In the molybdenum complex (A), the alkyl group is, for example, a C₁₋₁₀ alkyl group, and is preferably a C₁₋₁₀ alkyl group, more preferably a C₃₋₆ alkyl group, still more preferably an isopropyl group, a t-butyl group, or a cyclohexyl group. In the molybdenum complex (A), the alkoxy group is, for example, a C₁₋₈ alkoxy group or a benzyloxy group, and is preferably a C₁₋₈ alkoxy group. When the alkoxy group is a benzyloxy group, at least one hydrogen atom on the benzene ring of the benzyloxy group may be substituted with a resin. Examples of the halogen atom include fluorine atom, chlorine atom, bromine atom, and iodine atom.

The molybdenum complex (A) is, for example, a molybdenum complex of the following Formula (A1), (A2), or (A3):

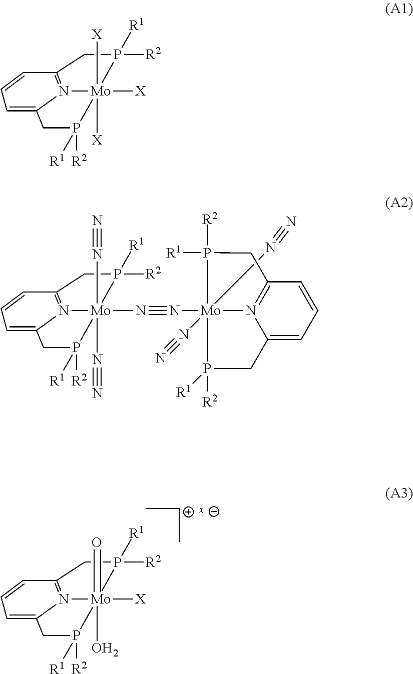

(wherein R¹ and R² are alkyl groups that may be identical to or different from each other; X is an iodine atom, a bromine atom, or a chlorine atom; and at least one hydrogen atom on the pyridine ring may be substituted with an alkyl group, an alkoxy group, or a halogen atom). Examples of the alkyl group, the alkoxy group, and the halogen atom include the same as those exemplified above. Each of R¹ and R² is preferably a bulky alkyl group, for example, a t-butyl group, an isopropyl group, or a cyclohexyl group. Preferably, no hydrogen atom on the pyridine ring is substituted, or the hydrogen atom at position 4 is substituted with a C₁₋₁₀ alkyl group, a C₁₋₈ alkoxy group, or a benzyloxy group. The alkoxy group is more preferably a benzyloxy group wherein at least one hydrogen atom on the benzene ring is substituted with a resin. Examples of the resin include a chloromethyl resin (e.g., polymer-bound 5-[4-(chloromethyl)phenyl]pentyl]styrene, polymer-bound 4-(benzyloxy)benzyl chloride, or polymer-bound 4-methoxybenzhydryl chloride), (chloromethyl)polystyrene, Merrifield resin, and JandaJel-Cl (trademark). Of these, (chloromethyl)polystyrene, Merrifield resin, and JandaJel-Cl (trademark) are preferred.

The molybdenum complex (B) is, for example, a molybdenum complex of the following Formula (B1) or (B2):

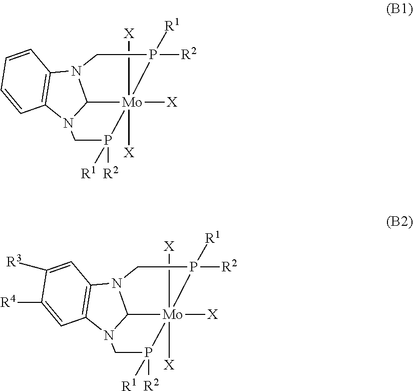

(wherein R¹ and R² are C₁₋₁₀ alkyl groups that may be identical to or different from each other; X is an iodine atom, a bromine atom, or a chlorine atom; and at least one hydrogen atom on the benzene ring of the molybdenum complex (B1) may be substituted with a C₁₋₁₀ alkyl group, a C₁₋₈ alkoxy group, or a halogen atom). Examples of the C₁₋₁₀ alkyl group, the C₁₋₈ alkoxy group, and the halogen atom include the same as those exemplified above. Each of R¹ and R² is preferably a bulky alkyl group such as a t-butyl group, an isopropyl group, or a cyclohexyl group.

R³ and R⁴ of the molybdenum complex (B2) are each independently an electron-withdrawing group, and both R³ and R⁴ may be electron-withdrawing groups. When R³ is an electron-withdrawing group, R⁴ may be a hydrogen atom. An electron-withdrawing group, which is also called an electron-attractive group or an electron-accepting group, refers to a substituent that attracts electrons from the bonding electron side as compared with a hydrogen atom, by the mesomeric effect or the inductive effect in the electronic theory; i.e., a theory that focuses on a change in electron density or bonding state of a substance and tries to interpret it as unified as possible.

The electron-withdrawing group is, for example, a substituent that has an electron-donating mesomeric effect but greatly contributes to an electron-withdrawing inductive effect, or a substituent that has electron-withdrawing mesomeric and inductive effects. Examples of the substituent that has an electron-donating mesomeric effect but greatly contributes to an electron-withdrawing inductive effect include a fluorine atom, a chlorine atom, a bromine atom, an iodine atom, —CH₂Cl, or —CH═CHNO₂. Examples of the substituent that has electron-withdrawing mesomeric and inductive effects include a quaternary ammonium group having an anion as a counter ion, a trifluoromethyl group, a perfluoroalkyl group, a trichloromethyl group, a cyano group, a nitro group, a formyl group, a carboxylic group, a sulfonic group, and a sulfonylamino group. Examples of the quaternary ammonium group include trialkylammonium groups, such as a trimethylammonium group, a triethylammonium group, and a tributylammonium group. Examples of the counter ion to the nitrogen atom forming the quaternary ammonium group include hexafluorophosphate ion, hexachloroantimonate ion, trifluoromethanesulfonate ion, tetrafluoroborate ion, phosphate ion, sulfonate ion, chloride, bromide, iodide, and hydroxide.

R³ and R⁴ are preferably a fluorine atom, a chlorine atom, a bromine atom, an iodine atom, and a trifluoromethyl group, more preferably a chlorine atom and a trifluoromethyl group.

The molybdenum complex (C) is, for example, a molybdenum complex of the following Formula (C1):

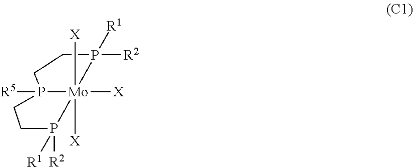

(wherein R¹ and R² are C₁₋₁₀ alkyl groups that may be identical to or different from each other; R⁵ is an Ar₆ aryl group; and X is an iodine atom, a bromine atom, or a chlorine atom). Examples of the C₁₋₁₀ alkyl group include the same as those exemplified above. Examples of the C₁₋₁₀ alkyl group and the Ar₆ aryl group include the same as those exemplified above. Each of R¹ and R² is preferably a bulky alkyl group such as a t-butyl group, an isopropyl group, or a cyclohexyl group. R⁵ is preferably a phenyl group.

The molybdenum complex (D) is, for example, a molybdenum complex of the following Formula (D1) or (D2):

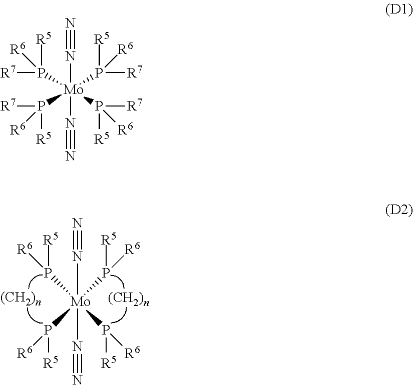

(wherein R⁵ and R⁶ are Ar₆ aryl groups that may be identical to or different from each other; R⁷ is a C₁₋₁₀ alkyl group; and n is 2 or 3). Examples of the Ar₆ aryl group and the C₁₋₁₀ alkyl group include the same as those exemplified above. In Formula (D1), preferably, R⁷ and R⁶ are a phenyl group, and R⁷ is a C₁₋₄ alkyl group. In Formula (D2), preferably, R⁵ and R⁶ are a phenyl group, and n is 2.

Examples of the solid catalyst used in the ammonia production method of the present embodiment include a metal catalyst and an oxide catalyst. Two or more species of these solid catalysts may be used in combination.

The metal catalyst may be used in a single composition, or may be used in the form of a mixture of a plurality of metal components, such as an alloy catalyst. The oxide catalyst used may be in the form of, for example, an oxide of a typical metal element, a transition metal oxide, or a mixture of a plurality of metal oxides. The metal oxide may be used as a solid catalyst carrier.

Examples of the solid catalyst used in the ammonia production method of the present embodiment include a metal catalyst and an oxide catalyst. Two or more species of these solid catalysts may be used in combination.

The metal catalyst may be used in a single composition, or may be used in the form of a mixture of a plurality of metal components, such as an alloy catalyst. The metal catalyst may be in the form of metal nanoparticles prepared with, for example, a surfactant. Alternatively, the metal catalyst may be in the form of, for example, metal particles, metal nanoparticles, metal film, or metal foil having a self-organized portion through bonding between the metal and thiol with use of a thiol compound. The thiol compound used may be, for example, a compound of R¹—SH (wherein R¹ has the same meaning as defined below). No particular limitation is imposed on R¹, and R¹ may be appropriately determined in consideration of, for example, the boiling point of R¹—SH or the ease of separation by chromatography. R¹ is preferably a C₁₋₂₋₀ organic group, more preferably a C₆₋₁₆ organic group. Examples of the organic group include a hydrocarbon group, a saturated chain hydrocarbon group, an unsaturated chain hydrocarbon group, a saturated cyclic hydrocarbon group, an unsaturated cyclic hydrocarbon group, an aromatic hydrocarbon group, a hydrocarbon group wherein carbon-carbon bonds are partially cleaved with a heteroatom, or a hydrocarbon group substituted with a substituent containing a heteroatom.

Specific examples of the thiol compound include 2-methylbenzenethiol, 3-methylbenzenethiol, 4-methylbenzenethiol, phenylmethanethiol, 1-butanethiol, 1-decanethiol, 1-dodecanethiol, 1-heptanethiol, 1-hexadecanethiol, 1-hexanethiol, 1-nonanethiol, 1-octadecanethiol, 1-octanethiol, 1-pentadecanethiol, 1-pentanethiol, 1-propanethiol, 1-tetradecanethiol, 1-undecanethiol, 11-mercaptoundecyl trifluoroacetate, 1H,1H,2H,2H-perfluorodecanethiol, 2-ethylhexanethiol, 2-methyl-1-propanethiol, 2-methyl-2-propanethiol, 3-methyl-1-butanethiol, methyl 3-mercaptopropionate, tert-dodecylmercaptan, (11-mercaptoundecyl)-N,N,N-trimethylammonium bromide, (11-mercaptoundecyl)hexa(ethylene glycol), (11-mercaptoundecyl)tetra(ethylene glycol), 1-(11-mercaptoundecyl)imidazole, 1-mercapto-2-propanol, 1141H-pyrrol-1-yl)undecane-1-thiol, 11-amino-1-undecanethiol hydrochloride, 11-mercapto-1-undecanol, 11-mercaptoundecanamide, 11-mercaptoundecanoic acid, 11-mercaptoundecylhydroquinone, 11-mercaptoundecylphosphonic acid, 12-mercaptododecanoic acid, 16-amino-1-hexadecanethiol hydrochloride, 16-mercaptohexadecanamide, 16-mercaptohexadecanoic acid, 3-amino-1-propanethiol hydrochloride, 3-chloro-1-propanethiol, 3-mercapto-1-propanol, 3-mercaptopropionic acid, 6-amino-1-hexanethiol hydrochloride, 6-mercapto-1-hexanol, 6-mercaptohexanoic acid, 8-amino-1-octanethiol hydrochloride, 8-mercapto-1-octanol, 8-mercaptooctanoic acid, 9-mercapto-1-nonanol, triethylene glycol mono-li-mercaptoundecyl ether, 1,4-butanediol diacetate, [11-(methylcarbonylthio)undecyl]hexa(ethylene glycol), [11-(methylcarbonylthio)undecyl]tetra(ethylene glycol), [11-(methylcarbonylthio)undecyl]tri(ethylene glycol) acetic acid, hexa(ethylene glycol) mono-11-(acetylthio)undecyl ether, S,S′-[1,4-phenylenebis(2,1-ethynediyl-4,1-phenylene)] bis(thioacetate), S-[4-[2-[4-(2-phenylethynyl)phenyl]ethynylphenyl] thioacetate, S-(10-undecyl) thioacetate, S-(11-bromoundecyl) thioacetate, S-(4-azidobutyl) thioacetate, S-(4-bromobutyl) thioacetate, S-(4-cyanobutyl) thioacetate, 1,1′,4′1″-terphenyl-4-thiol, 1,4-benzenemethanethiol, 1-adamantanethiol, 1-naphthalenethiol, 2-phenylethanethiol, 4′-bromo-4-mercaptophenyl, 4′-mercaptophenylcarbonitrile, 4,4′-bis(mercaptomethyl)biphenyl, 4,4′-dimercaptostilbene, 4-(6-mercaptohexyloxy)benzyl alcohol, 4-mercaptobenzoic acid, 9-fluorenylmethylthiol, 9-mercaptofluorene, biphenyl-4,4-dithiol, biphenyl-4-thiol, cyclohexanethiol, cyclopentanethiol, p-terphenyl-4,4″-dithiol, thiophenol, aminoethanethiol, aminopropanethiol, aminobutanethiol, methylaminoethanethiol, isopropylethylaminoethanethiol, dimethylaminoethanethiol, diethylaminoethanethiol, dibutylaminoethanethiol, mercaptoethylimidazole, mercaptopropylimidazole, mercaptobutylimidazole, mercaptohexylimidazole, mercaptotriazole, mercaptoethyltriazole, mercaptopropyltriazole, mercaptobutyltriazole, mercaptohexyltriazole, 3-mercaptopropylmethyldimethoxysilane, and 3-mercaptopropyltrimethoxysilane.

The oxide catalyst used may be in the form of, for example, an oxide of a typical metal element, a transition metal oxide, or a mixture of a plurality of metal oxides. The metal oxide may be used as a solid catalyst carrier.

Examples of the solid catalyst used in the ammonia production method of the present embodiment include an iridium(IV) oxide powder catalyst, an iridium oxide catalyst, catalysts of metals and alloys thereof, such as a platinum catalyst, a gold catalyst, a silver catalyst, a ruthenium catalyst, an iridium catalyst, a rhodium catalyst, a palladium catalyst, an osmium catalyst, a tungsten catalyst, a lead catalyst, an iron catalyst, a chromium catalyst, a cobalt catalyst, a nickel catalyst, a manganese catalyst, a vanadium catalyst, a molybdenum catalyst, a gallium catalyst, and an aluminum catalyst, aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, cerium oxide, samarium oxide, ruthenium oxide, oxide rhodium, silver oxide, tantalum oxide, tungsten oxide, osmium oxide, iridium oxide, indium oxide, platinum oxide, gold oxide, magnesium oxide, silica, silica-alumina, silica-magnesia, or a combination of the aforementioned solid catalysts.

Examples of the platinum catalyst, the gold catalyst, and the silver catalyst include a thiol-protected platinum nanoparticle catalyst, a thiol-protected platinum catalyst, a thiol-protected gold nanoparticle catalyst, a thiol-protected gold catalyst, a thiol-protected silver nanoparticle catalyst, or a thiol-protected silver catalyst.

Among these, the solid catalyst used on a cathode side is defined as “cathode solid catalyst.” Preferred cathode solid catalysts are a platinum catalyst, a thiol-protected platinum nanoparticle catalyst, a thiol-protected platinum catalyst, a gold catalyst, a thiol-protected gold nanoparticle catalyst, a thiol-protected gold catalyst, an iridium catalyst, a palladium catalyst, zinc oxide, molybdenum oxide, cerium oxide, and samarium oxide. More preferred cathode solid catalysts are a platinum catalyst, a thiol-protected platinum nanoparticle catalyst, a gold catalyst, a thiol-protected gold nanoparticle catalyst, a thiol-protected gold catalyst, a palladium catalyst, and zinc oxide. In the case where a plurality of these solid catalysts are used in combination, preferred combinations are a combination of a platinum catalyst and zinc oxide, a combination of a platinum catalyst and a gold catalyst, a combination of a platinum catalyst and a thiol-protected gold catalyst, a combination of a platinum catalyst and a palladium catalyst, a combination of a thiol-protected platinum nanoparticle catalyst and zinc oxide, a combination of a thiol-protected platinum nanoparticle catalyst and a gold catalyst, a combination of a thiol-protected platinum nanoparticle catalyst and a thiol-protected gold catalyst, and a combination of a thiol-protected platinum nanoparticle catalyst and a palladium catalyst.

The combination of a complex and a cathode solid catalyst (i.e., catalyst body) used on a cathode side in the ammonia production method of the present embodiment is defined as “cathode catalyst body.” Preferred combinations of the aforementioned cathode catalyst body are a combination of a molybdenum catalyst of Formula (A1) and a platinum catalyst, a combination of a molybdenum catalyst of Formula (A1) and a thiol-protected platinum nanoparticle catalyst, a combination of a molybdenum catalyst of Formula (A1) and a palladium catalyst, a combination of a molybdenum catalyst of Formula (A1) and a gold catalyst, a combination of a molybdenum catalyst of Formula (A1), a platinum catalyst, and a gold catalyst, a combination of a molybdenum catalyst of Formula (A1), a platinum catalyst, and a thiol-protected gold catalyst, a combination of a molybdenum catalyst of Formula (A1), a thiol-protected platinum nanoparticle catalyst, and a gold catalyst, a combination of a molybdenum catalyst of Formula (A1), a thiol-protected platinum nanoparticle catalyst, and a thiol-protected gold catalyst, a combination of a molybdenum catalyst of Formula (B2) and a platinum catalyst, a combination of a molybdenum catalyst of Formula (B2) and a thiol-protected platinum nanoparticle catalyst, a combination of a molybdenum catalyst of Formula (B2) and a palladium catalyst, a combination of a molybdenum catalyst of Formula (B2) and a gold catalyst, a combination of a molybdenum catalyst of Formula (B2), a platinum catalyst, and a gold catalyst, a combination of a molybdenum catalyst of Formula (B2), a platinum catalyst, and a thiol-protected gold catalyst, a combination of a molybdenum catalyst of Formula (B2), a thiol-protected platinum nanoparticle catalyst, and a gold catalyst, and a combination of a molybdenum catalyst of Formula (B2), a thiol-protected platinum nanoparticle catalyst, and a thiol-protected gold catalyst.

The cathode catalyst layer 103 used for the production of ammonia in the present embodiment contains a cathode catalyst body (i.e., a combination of a complex and a cathode solid catalyst), a catalyst carrier, an electronic conductor, an electrolyte, and a gas diffusion layer. The cathode catalyst layer 103, which contains the cathode catalyst body (i.e., a combination of a complex and a cathode solid catalyst), the catalyst carrier, the electronic conductor, the electrolyte, and the gas diffusion layer, may be referred to herein as “gas diffusion electrode 133.”

The catalyst carrier contained in the cathode catalyst layer 103 of the present embodiment may be responsible for electron conduction. No particular limitation is imposed on the catalyst carrier, so long as it supports the catalyst of the present embodiment. Examples of the catalyst carrier include carbon black, a carbon material, a metal mesh, a metal foam, a metal oxide, a composite oxide, a polymer electrolyte, and an ionic liquid. When the aforementioned catalyst carrier is used in the electrode, the catalyst carrier may not only play a role in supporting the catalyst, but may also be responsible, as a catalyst or a promoter, for the reaction occurring in the electrode.

Examples of the carbon black include channel black, furnace black, thermal black, acetylene black, ketjen black, and ketjen black EC. Examples of the carbon material include activated carbon prepared by carbonizing and activating various carbon-atom-containing materials, coke, natural graphite, artificial graphite, and graphitized carbon. Examples of the metal mesh include meshes of a metal such as nickel, tungsten, titanium, zirconium, or hafnium. Examples of the metal foam include foams of a metal such as aluminum, magnesium, tungsten, titanium, zirconium, hafnium, zinc, iron, tin, lead, or an alloy containing such a metal. Examples of the metal oxide include aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, gold oxide, magnesium oxide, or silica. Examples of the composite oxide include silica-alumina and silica-magnesia.

Examples of the polymer electrolyte include a fluorine-containing polymer electrolyte, a hydrocarbon polymer electrolyte, a carboxyl group-containing acrylic copolymer, or a carboxyl group-containing methacrylic copolymer.

Examples of the fluorine-containing polymer electrolyte include fluorine-containing sulfonic acid polymers, such as Nafion (registered trademark) available from DuPont, Aquivion (registered trademark) available from Solvay, FLEMION (registered trademark) available from AGC Inc., and Aciplex (registered trademark) available from Asahi Kasei Corporation, hydrocarbon-containing sulfonic acid polymers, and partially fluorine-introduced hydrocarbon-containing sulfonic acid polymers.

Examples of the hydrocarbon polymer electrolyte include sulfonated polyetherketone, sulfonated polyethersulfone, sulfonated polyetherethersulfone, sulfonated polysulfide, and sulfonated polyphenylene.

Specific examples of the carboxyl group-containing acrylic copolymer include homopolymers or copolymers of compounds having a carboxyl group and a copolymerizable double bond, such as acrylic acid, propiolic acid, crotonic acid, isocrotonic acid, myristoleic acid, palmitoleic acid, oleic acid, elaidic acid, vaccenic acid, gadoleic acid, eicosenoic acid, erucic acid, nervonic acid, ω-carboxy-polycaprolactone monoacrylate, phthalic acid monohydroxyethyl acrylate, acrylic acid dimer, 2-acryloyloxypropylhexahydrophthalic acid, 2-acryloyloxyethylsuccinic acid, maleic acid, fumaric acid, citraconic acid, mesaconic acid, atropic acid, cinnamic acid, linoleic acid, eicosadienoic acid, docosadienoic acid, linolenic acid, pinolenic acid, eleostearic acid, mead acid, dihomo-Y-linolenic acid, eicosatrienoic acid, stearidonic acid, arachidonic acid, eicosatetraenoic acid, adrenic acid, bosseopentaenoic acid, eicosapentaenoic acid, osbond acid, clupanodonic acid, tetracosapentaenoic acid, docosahexaenoic acid, nisinic acid, 2,2,2-trisacryloyloxymethylsuccinic acid, and 2-trisacryloyloxymethylethylphthalic acid; and copolymers containing a compound having a copolymerizable double bond, for example, an acrylic acid alkyl ester such as methyl acrylate, ethyl acrylate, butyl acrylate, isobutyl acrylate, tertiary-butyl acrylate, hexyl acrylate, 2-ethylhexyl acrylate, octyl acrylate, nonyl acrylate, decyl acrylate, dodecyl acrylate, or stearyl acrylate, an acrylamide compound such as diacetone acrylamide, acrylamide, 2-hydroxyethylacrylamide, N-methylacrylamide, N-t-butylacrylamide, N-isopropylacrylamide, N-phenylacrylamide, N-methylolacrylamide, dimethylaminopropylacrylamide, dimethylaminopropylacrylamide, diacetone acrylamide, N,N-dimethylacrylamide, N-vinylformamide, acryloylmorpholine, or acryloylpiperidine, a phosphonic acid compound such as [3-(acryloyloxy)propyl]phosphonic acid or [3-(methacryloyloxy)propyl]phosphonic acid, vinyl alcohol esters such as acrylonitrile and vinyl-n-butyl ether, acrylic acid tetrahydrofurfuryl ester, acrylic acid dimethylaminoethyl ester, acrylic acid diethylaminoethyl ester, acrylic acid glycidyl ester, 2,2,2-trifluoroethyl acrylate, 2,2,3,3-tetrafluoropropyl acrylate, styrene, or vinyltoluene. The aforementioned homopolymerization or copolymerization can be allowed to proceed by, for example, generating radicals with a radical polymerization initiator. Examples of the radical polymerization initiator include azo compounds such as azobisisobutyronitrile, azobis(2-methylbutyronitrile), 2,2′-azobis-2,4-dimethylvaleronitrile, and 2,2′-azobis[N-(2-carboxyethyl)-2-methylpropionamidinemethyl] tetrahydrate, organic peroxides such as t-butyl hydroperoxide, cumene hydroperoxide, benzoyl peroxide, dicumyl peroxide, and di-t-butyl peroxide, persulfates such as potassium persulfate, sodium persulfate, and ammonium persulfate, and hydrogen peroxide. These radical polymerization initiators may be used alone or in combination of two or more species. Specific examples of the carboxyl group-containing methacrylic copolymer include homopolymers or copolymers of compounds having a carboxyl group and a copolymerizable double bond, such as methacrylic acid, ω-carboxy-polycaprolactone monomethacrylate, phthalic acid monohydroxyethyl methacrylate, methacrylic acid dimer, 2-methacryloyloxypropylhexahydrophthalic acid, and 2-methacryloyloxyethylsuccinic acid; and copolymers containing a compound having a copolymerizable double bond, for example, a methacrylic acid alkyl ester such as methyl methacrylate, ethyl methacrylate, butyl methacrylate, isobutyl methacrylate, tertiary-butyl methacrylate, hexyl methacrylate, 2-ethylhexyl methacrylate, octyl methacrylate, nonyl methacrylate, decyl methacrylate, dodecyl methacrylate, or stearyl methacrylate, a methacrylamide compound such as methacrylamide or dimethylaminopropylmethacrylamide, a phosphonic acid compound such as α-phosphono-ω-(methacryloyloxy)poly(n=1 to 15)(oxypropylene), methacrylic acid tetrahydrofurfuryl ester, methacrylic acid dimethylaminoethyl ester, methacrylic acid diethylaminoethyl ester, methacrylic acid glycidyl ester, 2,2,2-trifluoroethyl methacrylate, 2,2,3,3-tetrafluoropropyl methacrylate, styrene, or vinyltoluene. The aforementioned homopolymerization or copolymerization can be allowed to proceed by, for example, generating radicals with a radical polymerization initiator.

Examples of the radical polymerization initiator include azo compounds such as azobisisobutyronitrile, azobis(2-methylbutyronitrile), 2,2-azobis-2,4-dimethylvaleronitrile, and 2,2-azobis[N-(2-carboxyethyl)-2-methylpropionamidinemethyl] tetrahydrate, organic peroxides such as t-butyl hydroperoxide, cumene hydroperoxide, benzoyl peroxide, dicumyl peroxide, and di-t-butyl peroxide, persulfates such as potassium persulfate, sodium persulfate, and ammonium persulfate, and hydrogen peroxide. These radical polymerization initiators may be used alone or in combination of two or more species.

The polymer electrolyte used may be a combination of a plurality of the aforementioned polymer electrolytes. The polymer alloy (i.e., a mixture of two or more polymers) may include, for example, a polymer blend prepared by physical mixing of two or more polymers, and interpenetrated polymer network (IPN) prepared by entanglement of polymer networks.

The ionic liquid of the present embodiment will next be described. The ionic liquid is, for example, an imidazolium salt, a pyridinium salt, an ammonium salt, a phosphonium salt, a pyrrolidinium salt, a piperidinium salt, or a sulfonium salt.

Specific examples of the imidazolium salt include a salt of the following Formula (1):

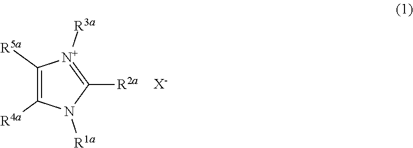

In Formula (1), each of R^{1a} to R^{5a}, which may be identical to or different from one another, is, for example, a hydrogen atom, a C₁₋₁₀ alkyl group, an allyl group, or a vinyl group. In Formula (1), X⁻ is, for example, chlorine ion, bromine ion, iodine ion, tetrafluoroborate, trifluoro(trifluoromethyl)borate, dimethyl phosphate ion, diethyl phosphate ion, hexafluorophosphate, tris(pentafluoroethyl) trifluorophosphate, trifluoroacetate, methyl sulfate, trifluoromethanesulfonate, or bis(trifluoromethanesulfonyl)imide.

Specific examples of the salt of Formula (1) include salts formed of Xin Formula (1) and an imidazolium ion such as 1-allyl-3-methylimidazolium ion, 3-ethyl-1-vinylimidazolium ion, 1-methylimidazolium ion, 1-ethylimidazolium ion, 1-n-propylimidazolium ion, 1,3-dimethylimidazolium ion, 1,2,3-trimethylimidazolium ion, 1-ethyl-3-methylimidazolium ion, 1-ethyl-2,3-dimethylimidazolium ion, 1,2,3,4-tetramethylimidazolium ion, 1,3-diethylimidazolium ion, 1-methyl-3-n-propylimidazolium ion, 1-ethyl-3-methylimidazolium ion, 2-ethyl-1,3-dimethylimidazolium ion, 1-ethyl-2,3-dimethylimidazolium ion, 1,3-dimethyl-n-propylimidazolium ion, 1,3,4-trimethylimidazolium ion, 2-ethyl-1,3,4-trimethylimidazolium ion, 1,2-dimethyl-3-propylimidazolium ion, 1-butyl-2,3-dimethylimidazolium ion, 1-butyl-3-methylimidazolium ion, 1-hexyl-3-methylimidazolium ion, or 1-methyl-3-n-octylimidazolium ion.

Specific examples of the pyridinium salt include a salt of the following Formula (2):

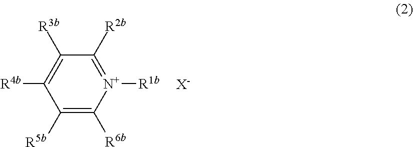

In Formula (2), each of R^{1b} to R^{6b}, which may be identical to or different from one another, is a hydrogen atom, a hydroxymethyl group, or a C₁₋₆ alkyl group. In Formula (2), XC is, for example, the same as those exemplified above in Formula (I).

Specific examples of the salt of Formula (2) include salts formed of XC in Formula (1) and a pyridinium ion such as 1-butyl-3-methylpyridinium ion, 1-butyl-4-methylpyridinium ion, 1-butyl-pyridinium ion, 1-ethyl-3-methylpyridinium ion, 1-ethylpyridinium ion, or 1-ethyl-3-(hydroxymethyl)pyridinium ion.

Specific examples of the ammonium salt include a salt of the following Formula (3):

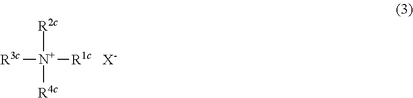

In Formula (3), each of R^{1c} to R^{4c}, which may be identical to or different from one another, is a hydrogen atom, a methoxyethyl group, a phenylethyl group, a methoxypropyl group, a cyclohexyl group, or a C₁₋₈ alkyl group. In Formula (3), X⁻ is, for example, the same as those exemplified above in Formula (1).

Specific examples of the salt of Formula (3) include salts formed of X⁻ in Formula (1) and an ammonium ion such as triethylpentylammonium ion, diethyl(methyl)propylammonium ion, methyltri-n-octylammonium ion, trimethylpropylammonium ion, cyclohexyltrimethylammonium ion, diethyl(2-methoxyethyl)-methylammonium ion, ethyl(2-methoxyethyl)-dimethylammonium ion, ethyl(3-methoxypropyl)dimethyl-ammonium ion, or ethyl(dimethyl)(2-phenylethyl)-ammonium ion.

Specific examples of the phosphonium salt include a salt of the following Formula (4):

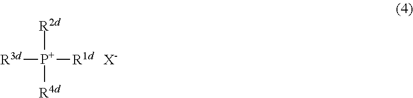

In Formula (4), each of R^{1d} to R^{4d}, which may be identical to or different from one another, is a hydrogen atom, a methoxyethyl group, or a C₁₋₁₀ alkyl group. In Formula (3), X⁻ is, for example, the same as those exemplified above in Formula (1).

Specific examples of the salt of Formula (4) include salts formed of X⁻ in Formula (1) and a phosphonium ion such as tributylmethylphosphonium ion, tetrabutylphosphonium ion, trihexyl(tetradecyl)phosphonium ion, trihexyl(ethyl)phosphonium ion, or tributyl(2-methoxyethyl)-phosphonium ion.

Specific examples of the pyrrolidinium salt include a salt of the following Formula (5):

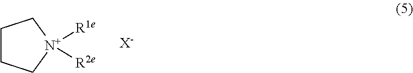

In Formula (5), each of R^{1e} and R^{2e}, which may be identical to or different from one another, is a hydrogen atom, an allyl group, a methoxyethyl group, or a C₁₋₈ alkyl group. In Formula (5), X⁻ is, for example, the same as those exemplified above in Formula (1).

Specific examples of the salt of Formula (5) include salts formed of X⁻ in Formula (1) and a pyrrolidinium ion such as 1-allyl-1-methylpyrrolidinium ion, 1-(2-methoxyethyl)-1-methylpyrrolidinium ion, 1-butyl-1-methylpyrrolidinium ion, 1-methyl-1-propylpyrrolidinium ion, 1-octyl-1-methylpyrrolidinium ion, or 1-hexyl-1-methylpyrrolidinium ion.

Specific examples of the piperidinium salt include a salt of the following Formula (6):

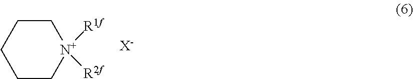

In Formula (6), each of R^{1f} and R^{2f}, which may be identical to or different from one another, is a hydrogen atom or a C₁₋₆ alkyl group. In Formula (6), X⁻ is, for example, the same as those exemplified above in Formula (1).

Specific examples of the salt of Formula (6) include salts formed of X⁻ in Formula (1) and a piperidinium ion such as 1-butyl-1-methylpiperidinium ion or 1-methyl-1-propylpiperidinium ion.

Specific examples of the sulfonium salt include a salt of the following Formula (7):

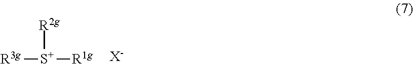

In Formula (7), R^{1g} to R^{3g}, which may be identical to or different from one another, is a hydrogen atom or a C₁₋₄ alkyl group. In Formula (3), X⁻ is, for example, the same as those exemplified above in Formula (1).

Specific examples of the salt of Formula (7) include salts formed of Xin Formula (1) and a sulfonium ion such as triethylsulfonium ion or trisulfonium ion.

More specific examples of the ionic liquid include 1-allyl-3-methylimidazolium chloride, 1-butyl-3-methylimidazolium bromide, 1-butyl-3-methylimidazolium tetrafluoroborate, 1-butyl-3-methylimidazolium hexafluorophosphate, 1-butyl-3-methylimidazolium trifluoromethanesulfonate, 1-butyl-3-methylimidazolium bis(trifluoromethanesulfonyl)imide, 1-butyl-3-methylimidazolium iodide, 1-butyl-3-methylimidazolium tris(pentafluoroethyl)trifluorotrifluorophosphate, 1-butyl-3-methylimidazolium trifluoro(trifluoromethyl)borate, 1-butyl-2,3-dimethylimidazolium trifluoromethanesulfonate, 1-butyl-3-methylimidazolium trifluoroacetate, 1-butyl-2,3-dimethylimidazolium trifluoromethanesulfonate, 1-butyl-3-methylimidazolium methylsulfate, 1,3-dimethylimidazolium dimethylphosphate, 2,3-dimethyl-1-propylimidazolium bis(trifluoromethanesulfonyl)imide, 1-decyl-3-methylimidazolium bis(trifluoromethanesulfonyl)imide, 1,3-dimethylimidazolium methylsulfate, 1-decyl-3-methylimidazolium bromide, 1-decyl-3-methylimidazolium chloride, 1-decyl-3-methylimidazolium tetrafluoroborate, 1-ethyl-3-methylimidazolium trifluoromethanesulfonate, 1-ethyl-3-methylimidazolium tetrafluoroborate, 1-ethyl-3-methylimidazolium bis(trifluoromethanesulfonyl)imide, 1-ethyl-2,3-dimethylimidazolium bis(trifluoromethanesulfonyl)imide, 1-ethyl-3-methylimidazolium methanesulfonate, 1-ethyl-3-methylimidazolium trifluoro(trifluoromethyl)borate, 3-ethyl-1-vinylimidazolium bis(trifluoromethanesulfonyl)imide, 1-ethyl-3-methylimidazolium trifluoroacetate, 1-ethyl-3-methylimidazolium methylsulfate, 1-ethyl-3-methylimidazolium diethylphosphate, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium trifluoromethanesulfonate, 1-hexyl-3-methylimidazolium bromide, 1-(2-hydroxyethyl)-3-methylimidazolium chloride, 1-hexyl-3-methylimidazolium bis(trifluoromethanesulfonyl)imide, 1-(2-hydroxyethyl)-3-methylimidazolium tetrafluoroborate, 1-hexyl-3-methylimidazolium iodide, 1-methyl-3-propylimidazolium iodide, 1-methyl-3-n-octylimidazolium bromide, 1-methyl-3-n-octylimidazolium chloride, 1-methyl-3-n-octylimidazolium hexafluorophosphate, 1-methyl-3-n-octylimidazolium trifluoromethanesulfonate, 1-methyl-3-n-octylimidazolium tetrafluoroborate, 1-methyl-3-propylimidazolium bromide, 1-methyl-3-propylimidazolium tetrafluoroborate, 1-methyl-3-pentylimidazolium bromide, 1-methyl-3-n-octylimidazolium bis(trifluoromethanesulfonyl)imide, 1-methyl-3-propylimidazolium bis(trifluoromethanesulfonyl)imide, 1-butylpyridinium tetrafluoroborate, 1-butyl-4-methylpyridinium tetrafluoroborate, 1-butylpyridinium bis(trifluoromethanesulfonyl)imide, 1-butyl-4-methylpyridinium bis(trifluoromethanesulfonyl)imide, 1-ethyl-3-methylpyridinium ethylsulfate, 1-ethyl-3-(hydroxymethyl)pyridinium ethylsulfate, 1-ethyl-3-methylpyridinium bis(trifluoromethanesulfonyl)imide, triethylpentylammonium bis(trifluoromethanesulfonyl)imide, diethyl(methyl)propylammonium bis(fluorosulfonyl)imide, diethyl(2-methoxyethyl)methylammonium bis(fluorosulfonyl)imide, ethyl(2-methoxyethyl)dimethylammonium bis(fluorosulfonyl)imide, ethyl(2-methoxyethyl)dimethylammonium bis(trifluoromethanesulfonyl)imide, ethyl(3-methoxypropyl)dimethylammonium bis(trifluoromethanesulfonyl)imide, ethyl(dimethyl)(2-phenylethyl)ammonium bis(trifluoromethanesulfonyl)imide, methyltri-n-octylammonium bis(trifluoromethanesulfonyl)imide, tributylmethylammonium bis(trifluoromethanesulfonyl)imide, trimethylpropylammonium bis(trifluoromethanesulfonyl)imide, tributylmethylphosphonium bis(trifluoromethanesulfonyl)imide, 1-allyl-1-methylpyrrolidinium bis(trifluoromethanesulfonyl)imide, 1-butyl-1-methylpyrrolidinium bis(fluorosulfonyl)imide, 1-butyl-1-methylpyrrolidinium trifluoromethanesulfonate, 1-methyl-1-propylpyrrolidinium bis(trifluoromethanesulfonyl)imide, 1-methyl-1-propylpyrrolidinium bis(fluorosulfonyl)imide, 1-(2-methoxyethyl)-1-methylpyrrolidinium bis(fluorosulfonyl)imide, 1-butyl-1-methylpiperidinium bis(trifluoromethanesulfonyl)imide, 1-methyl-1-propylpiperidinium bis(fluorosulfonyl)imide, or triethylsulfonium bis(trifluoromethanesulfonyl)imide, or any combination of the aforementioned ionic liquids.

Among the aforementioned compounds, the catalyst carrier of the present embodiment is preferably carbon black, ketjen black, ketjen black EC, Nafion (registered trademark), 1-butyl-3-methylimidazolium bis(trifluoromethanesulfonyl)imide, 1-butyl-1-methylpyrrolidinium bis(fluorosulfonyl)imide, or 1-butyl-3-methylimidazolium tris(pentafluoroethyl)trifluorotrifluorophosphate. These catalyst carriers may be used alone or in combination of two or more species. Preferred are a combination of carbon black and zinc oxide, a combination of ketjen black EC and zinc oxide, a combination of carbon black and molybdenum oxide, a combination of ketjen black EC and molybdenum oxide, a combination of carbon black, zinc oxide, and 1-butyl-3-methylimidazolium bis(trifluoromethanesulfonyl)imide, a combination of ketjen black EC, zinc oxide, and 1-butyl-3-methylimidazolium bis(trifluoromethanesulfonyl)imide, a combination of carbon black, zinc oxide, and 1-butyl-3-methylimidazolium tris(pentafluoroethyl)trifluorotrifluorophosphate, and a combination of ketjen black EC, zinc oxide, and 1-butyl-3-methylimidazolium tris(pentafluoroethyl)trifluorotrifluorophosphate.

No particular limitation is imposed on the electronic conductor contained in the cathode catalyst layer 103 of the present embodiment, so long as it is responsible for electron conduction. Examples of the electronic conductor include carbon black such as channel black, furnace black, thermal black, acetylene black, ketjen black, or ketjen black EC; a carbon material such as activated carbon prepared by carbonizing and activating various carbon-atom-containing materials, coke, natural graphite, artificial graphite, or graphitized carbon; a metal mesh formed of nickel or titanium; and a metal foam.

Of these, the electronic conductor of the present embodiment is preferably carbon black, ketjen black, ketjen black EC, nickel metal mesh, titanium metal mesh, and a metal foam, from the viewpoint of high specific surface area and excellent electron conductivity, and is more preferably titanium metal mesh and a metal foam, from the viewpoint of excellent durability.

No particular limitation is imposed on the electrolyte contained in the cathode catalyst layer 103 of the present embodiment, so long as it is responsible for ion conduction. Examples of the electrolyte include a fluorine-containing polymer electrolyte and a hydrocarbon polymer electrolyte. Examples of the fluorine-containing polymer electrolyte include fluorine-containing sulfonic acid polymers, such as Nafion (registered trademark) available from DuPont, Aquivion (registered trademark) available from Solvay, FLEMION (registered trademark) available from AGC Inc., and Aciplex (registered trademark) available from Asahi Kasei Corporation, hydrocarbon-containing sulfonic acid polymers, and partially fluorine-introduced hydrocarbon-containing sulfonic acid polymers. Examples of the hydrocarbon polymer electrolyte include sulfonated polyetherketone, sulfonated polyethersulfone, sulfonated polyetherethersulfone, sulfonated polysulfide, and sulfonated polyphenylene.

Of these, the electrolyte contained in the cathode catalyst layer 103 of the present embodiment is preferably an electrolyte responsible for proton conduction. Specifically, Nafion, Aquivion, FLEMION, or Aciplex is preferred. A plurality of the aforementioned electrolytes may be used in combination. The electrolyte preferably contains a perfluorate-containing polymer such as Nafion.

No particular limitation is imposed on the gas diffusion layer contained in the cathode catalyst layer 103 of the present embodiment, so long as it is responsible for electron conduction, gas diffusion, and electrolytic solution diffusion. Examples of the gas diffusion layer include carbon paper, carbon felt, or carbon cloth. The cathode catalyst layer 103, which contains the catalyst body (i.e., a complex, a cathode solid catalyst, or both a complex and a cathode solid catalyst) and the gas diffusion layer, may be referred to herein as “gas diffusion electrode 133.”

Examples of the carbon paper include TGP-H-060, TGP-H-090, TGP-H-120, TGP-H-060H, TGP-H-090H, and TGP-H-120H available from Toray Industries, Inc.; EC-TP1-030T, EC-TP1-060T, EC-TP1-090T, and EC-TP1-120T available from Electrochem; and 22BB, 28BC, 36BB, and 39BB available from SIGRACET. Examples of the carbon cloth include EC-CC1-060, EC-CC1-060T, and EC-CCC-060 available from Electrochem; and Torayca (registered trademark) Cloth C06142, C06151B, C06343, C06343B, C06347B, C06644B, C01302, C01303, C05642, C07354, C07359B, CK6244C, CK6273C, and CK6261C available from Toray Industries, Inc. Examples of the carbon felt include H1410 and H2415 available from Freudenberg.

Of these, the gas diffusion layer contained in the cathode catalyst layer 103 of the present embodiment is preferably TGP-H-060, TGP-H-090, TGP-H-060H, TGP-H-090H, or EC-TP1-060T.

In the ammonia production method of the present embodiment, the proton source disposed in the electrolyzer is, for example, the electrolyte membrane 102 disposed lateral to the cathode catalyst layer 103, an electrolytic solution derived from the aforementioned electrolyte membrane, or an electrolytic solution contained in the electrolytic solution bath disposed lateral to the cathode catalyst layer 103. No particular limitation is imposed on the electrolytic solution, so long as it is a solution containing an electrolyte and is responsible for proton conduction. These proton sources may be used alone or in combination of two or more species.

Examples of the solvent of the electrolytic solution used in the ammonia production method of the present embodiment include water, an ionic liquid, methanol, isopropyl alcohol, N,N-dimethylformamide, N,N-dimethylacetamide, dimethyl sulfoxide, N-methylpyrrolidone, diethylamine, hexamethylphosphonic triamide, acetic acid, acetonitrile, methylene chloride, trifluoroethanol, nitromethane, sulfolane, pyridine, tetrahydrofuran, dimethoxyethane, and propylene carbonate. Of these, water and an ionic liquid are preferred.

As described above, examples of the ionic liquid include an imidazolium salt, a pyridinium salt, an ammonium salt, a phosphonium salt, a pyrrolidinium salt, a piperidinium salt, or a sulfonium salt.

An acid such as sulfuric acid or trifluoromethanesulfonic acid may be added to the ionic liquid. The ionic liquid to which an acid is added is preferably 1-butyl-3-methylimidazolium bis(trifluoromethanesulfonyl)imide, 1-butyl-1-methylpiperidinium bis(trifluoromethanesulfonyl)imide, or 1-butyl-3-methylimidazolium tris(pentafluoroethyl)trifluorotrifluorophosphate.

Examples of the electrolyte contained in the electrolytic solution used in the ammonia production method of the present embodiment include a single cation or a combination of a plurality of cations, such as proton, lithium ion, sodium ion, potassium ion, imidazolium ion, pyridinium ion, quaternary ammonium ion, phosphonium ion, pyrrolidinium ion, and phosphonium ion; and a single anion or a combination of a plurality of anions, such as chlorine ion, bromine ion, iodine ion, tetrafluoroborate, trifluoro(trifluoromethyl)borate, dimethylphosphate ion, diethylphosphate ion, hexafluorophosphate, tris(pentafluoroethyl)trifluorophosphate, trifluoroacetate, methylsulfate, trifluoromethanesulfonate, bis(trifluoromethanesulfonyl)imide, perchlorate ion, sulfate ion, and nitrate ion. The aforementioned electrolytes may be used alone or in combination of two or more species.

Examples of the quaternary ammonium ion of the electrolyte include triethylpentylammonium ion, diethyl(methyl)propylammonium ion, methyltri-n-octylammonium ion, trimethylpropylammonium ion, cyclohexyltrimethylammonium ion, diethyl(2-methoxyethyl)-methylammonium ion, ethyl(2-methoxyethyl)-dimethylammonium ion, ethyl(3-methoxypropyl)dimethyl-ammonium ion, ethyl(dimethyl)(2-phenylethyl)-ammonium ion, tetramethylammonium ion, tetraethylammonium ion, triethylpentylammonium ion, tetra-n-butylammonium ion, diethyl(methyl)propylammonium ion, methyltri-n-octylammonium ion, trimethylpropylammonium ion, cyclohexyltrimethylammonium ion, diethyl(2-methoxyethyl)-methylammonium ion, ethyl(2-methoxyethyl)-dimethylammonium ion, ethyl(3-methoxypropyl)dimethyl-ammonium ion, and ethyl(dimethyl)(2-phenylethyl)-ammonium ion.

Specific examples of the imidazolium ion, pyridinium ion, phosphonium ion, pyrrolidinium ion, and phosphonium ion of the electrolyte are those described above.

The cation of the electrolyte contained in the electrolytic solution of the present embodiment is preferably proton, imidazolium ion, or pyrrolidinium ion, and the anion of the electrolyte is preferably perchlorate ion or sulfate ion.

The cathode electrolytic solution 106 used in the cathode electrolytic solution bath 105 of the present embodiment is preferably specifically water, an aqueous sulfuric acid solution, or 1-butyl-3-methylimidazolium bis(trifluoromethanesulfonyl)imide. These may be used singly or in combination of two or more species.

The anode electrolytic solution 116 used in the anode electrolytic solution bath 115 of the present embodiment is preferably specifically water or an aqueous sulfuric acid solution.

Examples of the electrolyte membrane 102 used in the ammonia production method of the present embodiment include a polymer electrolyte membrane. Examples of the polymer electrolyte membrane include Neosepta (registered trademark) available from ASTOM Corporation, SELEMION (registered trademark) available from AGC Inc., Aciplex (registered trademark) available from Asahi Kasei Corporation, Fumasep (registered trademark) available from Fumatech, fumapem (registered trademark) available from Fumatech, Nafion (registered trademark) available from DuPont, Aquivion (registered trademark) available from Solvay, FLEMION (registered trademark) available from AGC Inc., and GORE-SELECT (registered trademark) available from Japan GORE. The electrolyte membrane 102 is preferably Aciplex (registered trademark) available from Asahi Kasei Corporation, Nafion (registered trademark) available from DuPont, Aquivion (registered trademark) available from Solvay, and FLEMION (registered trademark) available from AGC Inc.

In the ammonia production method of the present embodiment, the reaction temperature is preferably −40° C. to 120° C., more preferably 0° C. to 50° C. (i.e., ambient temperature). The reaction atmosphere may be a pressurized atmosphere, and is generally an ambient pressure atmosphere. No particular limitation is imposed on the reaction time, and it is generally determined within a range of several tens of minutes to several tens of hours. The reaction may be performed continuously or intermittently. For example, the reaction may be performed for several hours, temporarily stopped, and then resumed.

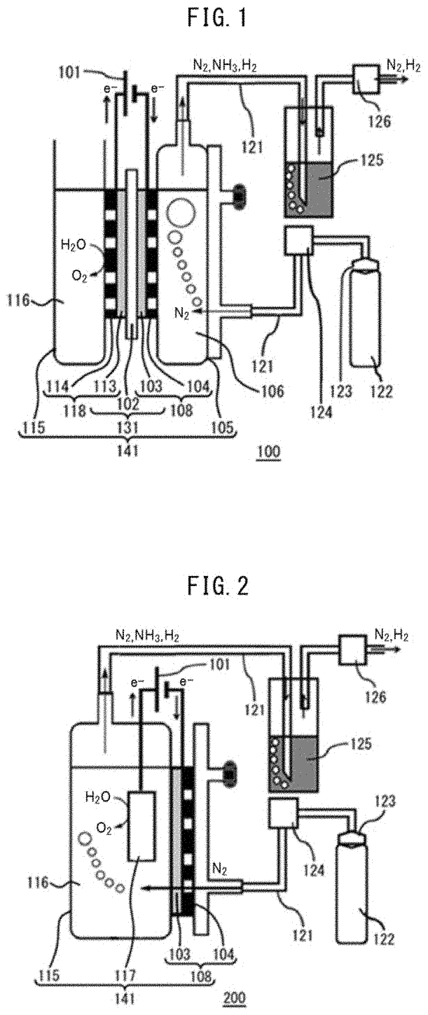

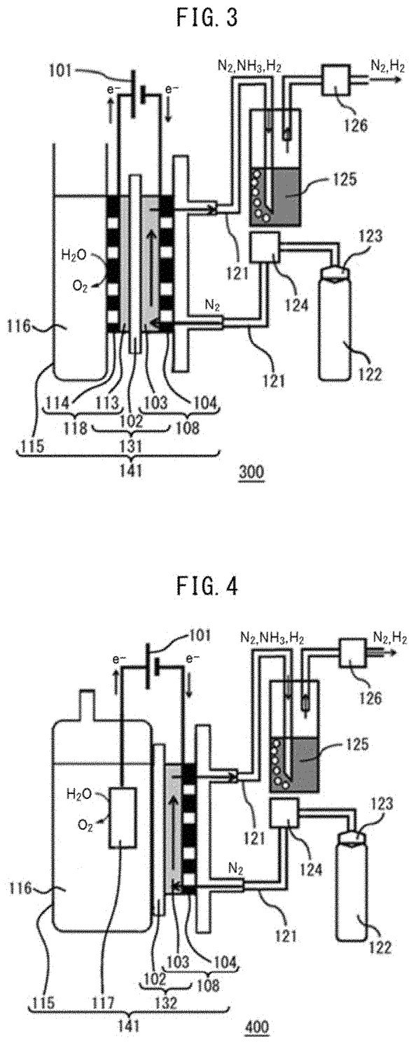

Next will be described the ammonia production method and production apparatus (electrolyzer) of the present embodiment. FIG. 1 shows an ammonia electrolyzer (No. 1) 100 of example 1 for ammonia production, FIG. 2 shows an ammonia electrolyzer (No. 2) 200 of example 2 for ammonia production, FIG. 3 shows an ammonia electrolyzer (No. 3) 300 of example 3 for ammonia production, and FIG. 4 shows an ammonia electrolyzer (No. 4) 400 of example 4 for ammonia production.

The ammonia electrolyzer (No. 1) 100 of the present embodiment is an ammonia production apparatus including a membrane electrode assembly 131 including a cathode 108 and an anode 118, wherein a cathode catalyst layer 103 and an anode catalyst layer 113 are integrated with the intervention of an electrolyte membrane 102. The production apparatus is configured such that the cathode catalyst layer 103 is bonded to one side of the electrolyte membrane 102, a cathode collector 104 is disposed outside of the cathode catalyst layer 103, the anode catalyst layer 113 is bonded to the other side of the electrolyte membrane 102, and an anode collector 114 is disposed outside of the anode catalyst layer 113.

The cathode catalyst layer 103 contains a complex and a cathode solid catalyst, and the anode catalyst layer 113 contains an anode solid catalyst.

The production apparatus includes a cathode electrolytic solution bath 105 of a cathode electrolytic solution 106 which is in liquid contact with the cathode 108 of the membrane electrode assembly 131; an anode electrolytic solution bath 115 of an anode electrolytic solution 116 which is in liquid contact with the anode 118 of the membrane electrode assembly 131; a power source (power source apparatus 101) for supplying electrons to the cathode 108; a proton source for supplying protons to the cathode 108; and means for supplying nitrogen gas to the cathode electrolytic solution 106 and the cathode 108. The proton source is the electrolyte membrane 102, the cathode electrolytic solution 106, the anode electrolytic solution 116, both the electrolyte membrane 102 and the cathode electrolytic solution 106, or both the electrolyte membrane 102 and the anode electrolytic solution 116. In the ammonia production apparatus, ammonia is produced from nitrogen molecules by electrolysis.

The nitrogen gas supply means is configured so as to supply nitrogen gas from a nitrogen cylinder 122 through a pipe 121 via a nitrogen cylinder regulator 123 and a nitrogen gas mass flow controller 124.

Ammonia produced at the cathode 108 can be collected in the cathode electrolytic solution bath 105 of the cathode electrolytic solution 106 and a dilute aqueous sulfuric acid solution bath 125 for ammonia collection. By-produced hydrogen and unreacted nitrogen pass through the pipe 121 and through the dilute aqueous sulfuric acid solution bath 125 for ammonia collection, and then are discharged to the outside through a draft apparatus 126.

The ammonia electrolyzer (No. 2) 200 of the present embodiment is an ammonia production apparatus including a cathode 108 composed of a cathode catalyst layer 103 and a cathode collector 104, and a metal plate electrode 117 serving as an anode.

The cathode catalyst layer 103 contains a complex and a cathode solid catalyst and is a gas diffusion electrode 133.

The production apparatus includes an anode electrolytic solution bath 115 of an anode electrolytic solution 116 which is in liquid contact with the cathode catalyst layer 103; a power source (power source apparatus 101) for supplying electrons to the cathode 108; a proton source for supplying protons to the cathode 108; and means for supplying nitrogen gas to the cathode 108. The gas diffusion layer of the cathode catalyst layer 103 is preferably formed of water-repellent carbon paper treated with a fluororesin containing polytetrafluoroethylene (may be abbreviated as “PTFE”). Specifically, the carbon paper is preferably TGP-H-060H, TGP-H-090H, TGP-H-120H, EC-TP1-030T, EC-TP1-060T, EC-TP1-090T, or EC-TP1-120T. The proton source is the anode electrolytic solution 116. In the ammonia production apparatus, ammonia is produced from nitrogen molecules by electrolysis.

The nitrogen gas supply means is configured so as to supply nitrogen gas from a nitrogen cylinder 122 through a pipe 121 via a nitrogen cylinder regulator 123 and a nitrogen gas mass flow controller 124.

Ammonia produced at the cathode 108 can be collected in the anode electrolytic solution bath 115 of the anode electrolytic solution 116 and a dilute aqueous sulfuric acid solution bath 125 for ammonia collection. By-produced hydrogen and unreacted nitrogen pass through the pipe 121 and through the dilute aqueous sulfuric acid solution bath 125 for ammonia collection, and then are discharged to the outside through a draft apparatus 126.

The ammonia electrolyzer (No. 3) 300 of the present embodiment is an ammonia production apparatus including a membrane electrode assembly 131 including a cathode 108 and an anode 118, wherein a cathode catalyst layer 103 and an anode catalyst layer 113 are integrated with the intervention of an electrolyte membrane 102. The production apparatus is configured such that the cathode catalyst layer 103 is bonded to one side of the electrolyte membrane 102, a cathode collector 104 is disposed outside of the cathode catalyst layer 103, the anode catalyst layer 113 is bonded to the other side of the electrolyte membrane 102, and an anode collector 114 is disposed outside of the anode catalyst layer 113.

The cathode catalyst layer 103 contains a complex and a cathode solid catalyst, and the anode catalyst layer 113 contains an anode solid catalyst.

The production apparatus includes an anode electrolytic solution bath 115 of an anode electrolytic solution 116 which is in liquid contact with the anode 118 of the membrane electrode assembly 131; a power source (power source apparatus 101) for supplying electrons to the cathode 108; a proton source for supplying protons to the cathode 108; and means for supplying nitrogen gas to the cathode electrolytic solution 106 and the cathode 108. The proton source is the electrolyte membrane 102, the anode electrolytic solution 116, or both the electrolyte membrane 102 and the anode electrolytic solution 116. In the ammonia production apparatus, ammonia is produced from nitrogen molecules by electrolysis.

The nitrogen gas supply means is configured so as to supply nitrogen gas from a nitrogen cylinder 122 through a pipe 121 via a nitrogen cylinder regulator 123 and a nitrogen gas mass flow controller 124.

Ammonia produced at the cathode 108 can be collected in a dilute aqueous sulfuric acid solution bath 125 for ammonia collection. By-produced hydrogen and unreacted nitrogen pass through the pipe 121 and through the dilute aqueous sulfuric acid solution bath 125 for ammonia collection, and then are discharged to the outside through a draft apparatus 126.

The ammonia electrolyzer (No. 4) 400 of the present embodiment is an ammonia production apparatus including a cathode 108 composed of a cathode collector 104 and a cathode membrane electrode assembly 132 including an electrolyte membrane 102 and a cathode catalyst layer 103 bonded to one side of the electrolyte membrane 102, and a metal plate electrode 117 serving as an anode.

The cathode catalyst layer 103 contains a complex and a cathode solid catalyst. The production apparatus includes an anode electrolytic solution bath 115 of an anode electrolytic solution 116 which is in liquid contact with the electrolyte membrane 102 of the cathode membrane electrode assembly 132; a power source (power source apparatus 101) for supplying electrons to the cathode 108; a proton source for supplying protons to the cathode 108; and means for supplying nitrogen gas to the cathode 108. The proton source is the electrolyte membrane 102, the anode electrolytic solution 116, or both the electrolyte membrane 102 and the anode electrolytic solution 116. In the ammonia production apparatus, ammonia is produced from nitrogen molecules by electrolysis.

The nitrogen gas supply means is configured so as to supply nitrogen gas from a nitrogen cylinder 122 through a pipe 121 via a nitrogen cylinder regulator 123 and a nitrogen gas mass flow controller 124.

Ammonia produced at the cathode 108 can be collected in a dilute aqueous sulfuric acid solution bath 125 for ammonia collection. By-produced hydrogen and unreacted nitrogen pass through the pipe 121 and through the dilute aqueous sulfuric acid solution bath 125 for ammonia collection, and then are discharged to the outside through a draft apparatus 126.

Each of the cathode collector 104 and the anode collector 114 in the electrolyzer of the present embodiment is formed of, for example, carbon, a metal, an oxide, an alloy containing two or more metals, an oxide containing two or more metals, stainless steel, indium tin oxide, or indium zinc oxide. Examples of the metal include titanium, vanadium, chromium, manganese, iron, cobalt, nickel, copper, zinc, niobium, molybdenum, ruthenium, rhodium, silver, tantalum, tungsten, osmium, iridium, indium, platinum, and gold. Examples of the oxide include titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, and gold oxide.

No particular limitation is imposed on the form of the collector, so long as a gas or an electrolytic solution can pass through the collector. For example, the collector may be in a perforated, linear, rod, plate, foil, mesh, woven, non-woven, expanded, porous, or foam form. In order to prevent corrosion during ammonia production by electrolysis, the collector used may be plated with gold, etc.

In the electrolyzer of the present embodiment, nitrogen gas is supplied from the nitrogen cylinder 122, and the flow rate of nitrogen gas supplied may be controlled with the nitrogen cylinder regulator 123 and the nitrogen gas mass flow controller 124. For example, nitrogen gas may be supplied by bubbling into the cathode electrolytic solution bath 105 shown in FIG. 1 and the anode electrolytic solution bath 115 shown in FIG. 2. As shown in FIGS. 3 and 4, nitrogen gas may be supplied directly to the cathode catalyst layer 103 through holes of the cathode collector 104.

Now will be described the electrolytic reaction for ammonia production at the cathode catalyst layer 103 in the electrolyzer of the present embodiment. The catalyst body of the present embodiment (i.e., a combination of a complex and a solid catalyst) causes ammonia production reaction to occur from the following three species; i.e., nitrogen gas supplied to the cathode 108, protons supplied to the cathode 108, and electrons supplied from the power source apparatus 101. The reaction formula can be described as “N₂+6e⁻+6H⁺→2NH₃.”

While ammonia is produced at the cathode catalyst layer 103, hydrogen is by-produced due to the reaction between two species (i.e., hydroxonium ions or water and electrons) at the cathode catalyst layer. The by-produced hydrogen may be dissociated on the solid catalyst or on the catalyst carrier. For example, as described in Schreiber-Atkins Inorganic Chemistry (book 1), 6th Edition, page 358 (non-patent document), the hydrogen adsorbed on a platinum catalyst (i.e., a metal catalyst) is homolytically dissociated into hydrogen atoms, and the hydrogen adsorbed on zinc oxide (i.e., a metal oxide) is heterolytically dissociated into protons and hydrides. It is surmised that hydrogen atoms, protons, and hydrides activated on the solid catalyst promote the ammonia production reaction.

The ammonia produced at the cathode 108 may be fed to the dilute aqueous sulfuric acid solution bath 125 for ammonia collection together with by-produced hydrogen and unreacted nitrogen. Alternatively, the produced ammonia may be collected in the electrolytic solution used in the cathode electrolytic solution bath 105 or the anode electrolytic solution bath 115. In this case, the electrolytic solution used in the cathode electrolytic solution bath 105 is preferably water or a dilute aqueous sulfuric acid solution, from the viewpoint of recovery and reuse. The electrolytic solution in the cathode electrolytic solution bath 105 may be circulated with a pump to thereby increase ammonia collection efficiency.

As described above, the ammonia produced at the cathode catalyst layer 103 in the electrolyzer of the present embodiment can be selectively collected with water or a dilute aqueous sulfuric acid solution from a mixed gas containing the ammonia, by-produced hydrogen, and unreacted nitrogen. Thus, a mixed gas containing the by-produced hydrogen and nitrogen can be removed in parallel with collection of the ammonia. Hydrogen useful in view of energy carrier can also be obtained in the present embodiment. For the sake of safety, the by-produced hydrogen may be discharged to the outside through the draft apparatus 126.

A portion connected to the gas pipe or the electrolytic solution bath may be sealed with, for example, a putty or a sealing agent, to thereby prevent gas leakage or liquid leakage.

Now will be described the electrolytic reaction at the anode catalyst layer 113 or the metal plate electrode 117 in the electrolyzer of the present embodiment. The catalyst of the anode 118 causes a reaction for producing oxygen, electrons, and protons from water, and the reaction is represented by the formula “2H₂O→+O₂+4e⁻+4H⁺.” The produced protons are move to the cathode 108 through the electrolyte membrane 102 or the electrolytic solution, and the electrons move to the power source apparatus 101 through the anode collector 114 or the metal plate electrode 117. The produced oxygen may be released to air while a portion of the oxygen is dissolved in water contained in the anode electrolytic solution bath 115. Alternatively, the oxygen may be forcedly discharged by bubbling of nitrogen gas into the anode electrolytic solution bath 115.

The anode catalyst layer 113 in the electrolyzer of the present embodiment contains a solid catalyst, a catalyst carrier, an electrolyte, and a gas diffusion layer. The anode catalyst layer 113, which contains the anode solid catalyst, the catalyst carrier, the electronic conductor, the electrolyte, and the gas diffusion layer, may be referred to herein as “gas diffusion electrode 133.”

The solid catalyst contained in the anode catalyst layer 113 in the electrolyzer of the present embodiment is defined as “anode solid catalyst.” Examples of the anode solid catalyst include the same as those described above in the solid catalyst and cathode solid catalyst in the ammonia production method of the present embodiment. Specific examples of the anode solid catalyst include an iridium(IV) oxide powder catalyst, an iridium oxide catalyst, and catalysts of metals and alloys thereof, such as a platinum catalyst, a gold catalyst, a silver catalyst, a ruthenium catalyst, an iridium catalyst, a rhodium catalyst, a palladium catalyst, an osmium catalyst, a tungsten catalyst, a lead catalyst, an iron catalyst, a chromium catalyst, a cobalt catalyst, a nickel catalyst, a manganese catalyst, a vanadium catalyst, a molybdenum catalyst, a gallium catalyst, and an aluminum catalyst. Of these, the anode solid catalyst is preferably an iridium(IV) oxide powder catalyst, an iridium oxide catalyst, or a platinum catalyst.

The catalyst carrier contained in the anode catalyst layer 113 of the present embodiment may be responsible for electron conduction. No particular limitation is imposed on the catalyst carrier, so long as it supports the catalyst of the present embodiment. Examples of the catalyst carrier include carbon black, a carbon material, a metal mesh, a metal foam, a metal oxide, and a composite oxide.

Examples of the carbon black include channel black, furnace black, thermal black, acetylene black, ketjen black, and ketjen black EC. Examples of the carbon material include activated carbon prepared by carbonizing and activating various carbon-atom-containing materials, coke, natural graphite, artificial graphite, and graphitized carbon. Examples of the metal mesh include meshes of a metal such as nickel or titanium. Examples of the metal foam include foams of a metal such as aluminum, magnesium, titanium, zinc, iron, tin, lead, or an alloy containing such a metal. Examples of the metal oxide include aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, gold oxide, magnesium oxide, or silica. Examples of the composite oxide include silica-alumina and silica-magnesia. Of these, the catalyst carrier is preferably carbon black, ketjen black, ketjen black EC, nickel metal mesh, titanium metal mesh, titanium oxide, and a metal foam, from the viewpoint of high specific surface area and excellent electron conductivity, and is more preferably titanium metal mesh, titanium oxide, and a metal foam, from the viewpoint of excellent durability.

No particular limitation is imposed on the electrolyte contained in the anode catalyst layer 113 of the present embodiment, so long as it is responsible for ion conduction. Examples of the electrolyte include the same as those described above in the electrolyte contained in the cathode catalyst layer 103 of the present embodiment. Specific examples of the electrolyte include a fluorine-containing sulfonic acid polymer such as Nafion (registered trademark) available from DuPont, Aquivion (registered trademark) available from Solvay, FLEMION (registered trademark) available from AGC Inc., or Aciplex (registered trademark) available from Asahi Kasei Corporation, a hydrocarbon-containing sulfonic acid polymer, and a partially fluorine-introduced hydrocarbon-containing sulfonic acid polymer. Of these, the electrolyte is preferably an electrolyte responsible for proton conduction. Specifically, Nafion, Aquivion, FLEMION, or Aciplex is preferred. A plurality of the aforementioned electrolytes may be used in combination. The electrolyte preferably contains a perfluorate-containing polymer such as Nafion.

No particular limitation is imposed on the gas diffusion layer contained in the anode catalyst layer 113 of the present embodiment, so long as it is responsible for electron conduction, gas diffusion, and electrolytic solution diffusion. Examples of the gas diffusion layer include the same as those described above in the gas diffusion layer contained in the cathode catalyst layer 103 of the present embodiment. The gas diffusion layer is preferably carbon paper. Specific examples of the carbon paper include TGP-H-060, TGP-H-090, TGP-H-120, TGP-H-060H, TGP-H-090H, and TGP-H-120H available from Toray Industries, Inc.; EC-TP1-030T, EC-TP1-060T, EC-TP1-090T, and EC-TP1-120T available from Electrochem; and 22BB, 28BC, 36BB, and 39BB available from SIGRACET. Of these, the gas diffusion layer is preferably TGP-H-060, TGP-H-090, TGP-H-060H, TGP-H-090H, or EC-TP1-060T.

Specific examples of the metal of the metal plate electrode 117 of the present embodiment include stainless steel, indium tin oxide, indium zinc oxide, and metals and alloys thereof, such as titanium, vanadium, chromium, manganese, iron, cobalt, nickel, copper, zinc, niobium, molybdenum, ruthenium, rhodium, silver, tantalum, tungsten, osmium, iridium, indium, platinum, and gold. Of these, platinum is preferred. Examples of the form of the metal plate electrode 117 include linear, rod, plate, foil, mesh, woven, non-woven, expanded, porous, and foam forms. Preferred is a mesh or porous form.

Needless to say, the present invention is not limited to the aforementioned embodiment, and may be implemented in various modes, so long as they pertain to the technical scope of the present invention.

### EXAMPLES

The present invention will next be described by way of Examples. The present invention should not be construed as being limited to the Examples.

### Example 1

1. Assembly of Electrolyzer for Ammonia Production

The cathode catalyst layer 103 (i.e., catalyst body for ammonia production) was formed as described below. Catalyst ink A used for the cathode 108 is an ink for applying the cathode solid catalyst of the present embodiment to the cathode catalyst layer 103. Catalyst ink A was prepared by using a carbon black-supported platinum catalyst (trade name “TEC10E50E,” available from Tanaka Kikinzoku Kogyo K.K., platinum content: 46.6% by weight) serving as a solid catalyst, deionized water, ethanol, and a Nafion dispersion (trade name “5% Nafion Dispersion DE520 CS Type,” available from FUJIFILM Wako Pure Chemical Corporation) serving as an electrolyte. The carbon-supported platinum catalyst, deionized water, ethanol, and the Nafion dispersion were added in this order to a glass vial, and the resultant dispersion was irradiated with ultrasonic waves for 30 minutes with an ultrasonic homogenizer Smurt NR-50M available from MICROTEC CO., LTD. (output: 40%), to thereby prepare catalyst ink A. Subsequently, catalyst ink A was applied to carbon paper (trade name “TGP-H-060H,” available from Toray Industries, Inc.) fixed on a hot plate set at 80° C., and ethanol and water were dried. The amount of catalyst ink A applied was adjusted so that the amount of platinum was 1.0 mg per cm². Thus, the gas diffusion electrode 133 (hereinafter may be abbreviated as “GDE”) containing Nafion as an electrolyte and the carbon-supported platinum catalyst as a solid catalyst was formed. Specifically, the gas diffusion electrode 133 is a square (2.7×2.7 cm²) gas diffusion electrode 133 “GDE-Cathode-0” containing 7.3 mg of the applied platinum catalyst serving as a solid catalyst.

Subsequently, catalyst ink B for applying the complex of the present embodiment to the cathode catalyst layer 103 was prepared. Catalyst ink B was a solution prepared by dissolving 5.8 mg of a molybdenum complex of the following Formula (A1-1):

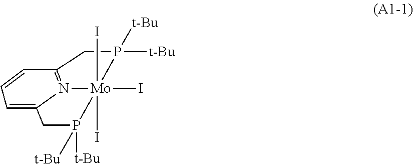

in 1.0 mL of dichloromethane. Thereafter, 50 μL of catalyst ink B was applied to the gas diffusion electrode 133 “GDE-Cathode-0,” and dichloromethane was dried, to thereby form the cathode catalyst layer 103. Specifically, the gas diffusion electrode 133 being the cathode catalyst layer 103 is a square (2.7×2.7 cm²) gas diffusion electrode 133 “GDE-Cathode-1” containing 7.3 mg of the applied platinum catalyst serving as a solid catalyst and 0.29 mg (0.33 μmol) of the applied molybdenum complex of Formula (A1-1).

Now will be described the amount of Nafion (hereinafter abbreviated as “ionomer”) contained in the aforementioned catalyst ink. Catalyst ink A was prepared so that the amount (% by weight) of the ionomer was 28% by weight as calculated by the following formula.

Amount of ionomer (% by weight)=[ionomer solid content (weight)/[{carbon-supported platinum catalyst (weight)+ionomer solid content (weight)}]×100

Specifically, when the ionomer was Nafion, the amount of the carbon-supported platinum catalyst was adjusted to 100.0 mg, the amount of the Nafion dispersion was adjusted to 837 μL, the amount of deionized water was adjusted to 0.6 mL, and the amount of ethanol was adjusted to 5 mL. The Nafion solid content in 837 μL of the Nafion dispersion was 38.9 mg.

The anode catalyst layer 113 was formed as described below. Catalyst ink A was prepared in the same manner as described in the cathode catalyst layer 103, and applied in the same manner as described above, to thereby form the gas diffusion electrode 133 as the anode catalyst layer 113 containing Nafion serving as an electrolyte and the carbon-supported platinum catalyst serving as a solid catalyst. Specifically, the gas diffusion electrode 133 being the anode catalyst layer 113 is a square (2.7×2.7 cm²) gas diffusion electrode 133 “GDE-Anode-0” containing 7.3 mg of the applied platinum catalyst serving as a solid catalyst.

[Electrolyzer (No. 1)]

A membrane electrode assembly (hereinafter may be abbreviated as “MEA”), which includes the electrolyte membrane 102, the cathode catalyst layer 103, and the anode catalyst layer 113, was formed as described below. The ion-exchange membrane used in the electrolyte membrane 102 was Nafion 212 membrane (registered trademark) available from DuPont (thickness: 50 μm, 5 cm×4 cm). The gas diffusion electrode 133 “GDE-Cathode-1” being the cathode catalyst layer was disposed on one surface of the ion-exchange membrane, and the gas diffusion electrode 133 “GDE-Anode-0” being the anode catalyst layer was disposed on the other surface of the ion-exchange membrane. Thereafter, the resultant laminate was subjected to thermocompression under the following conditions: temperature of upper and lower plates:132° C., load: 5.4 kN, and compression time: 240 seconds, to thereby form a membrane electrode assembly “MEA-1.”

Stainless steel collectors each having 25 circular holes (diameter: 2.5 mm) were attached to both surfaces of the above-formed MEA “MEA-1,” and the resultant product was attached to electrolytic baths together with Teflon (registered trademark) sheets serving as gaskets, to thereby assemble the electrolyzer (No. 1) 100 shown in FIG. 1.

[Electrolyzer (No. 3)]

The ammonia electrolyzer (No. 3) 300 shown in FIG. 3 (having no cathode electrolytic solution bath) was assembled with use of the resultant “MEA-1.”

[Electrolyzer (No. 2)]

Now will be described the assembly of the ammonia electrolyzer (No. 2) 200 shown in FIG. 2. The cathode was formed by attaching a stainless steel collector having 25 circular holes (diameter: 2.5 mm) to the gas diffusion electrode 133 “GDE-Cathode-1” being the cathode catalyst layer. The anode was the metal plate electrode 117 formed of a platinum mesh electrode. The ammonia electrolyzer (No. 2) 200 shown in FIG. 2 (having the aforementioned two electrodes) was assembled.

[Electrolyzer (No. 4)]

Now will be described the assembly of the ammonia electrolyzer (No. 4) 400 shown in FIG. 4. The cathode membrane electrode assembly 132 including the electrolyte membrane 102 and the cathode catalyst layer 103 was formed as described below. The ion-exchange membrane used in the electrolyte membrane was Nafion 212 membrane (registered trademark) available from DuPont (thickness: 50 μm, 5 cm×4 cm). The gas diffusion electrode 133 “GDE-Cathode-1” was disposed on one surface of the ion-exchange membrane, and the resultant laminate was subjected to thermocompression under the following conditions: temperature of upper and lower plates:132° C., load: 5.4 kN, and compression time: 240 seconds, to thereby form a single-sided membrane electrode assembly “MEA-2” (i.e., cathode membrane electrode assembly 132). The cathode was formed by attaching a stainless steel collector having 25 circular holes (diameter: 2.5 mm) to the surface of the “MEA-2” opposite the electrolyte membrane side. The anode was the metal plate electrode 117 formed of a platinum mesh electrode. The ammonia electrolyzer (No. 4) 400 shown in FIG. 4 (having the aforementioned two electrodes) was assembled.

2. Production of Ammonia with Electrolyzer

Ammonia was produced by electrolysis with the above-assembled electrolyzer (No. 1) for ammonia production under the following conditions.
Temperature of electrolyzer: 25 to 28° C. (room temperature)
Power source apparatus 101: the voltage and the current were measured with Versa STAT4 available from Princeton Applied Research.
Cathode electrolytic solution bath 105: 0.02 mol/L aqueous sulfuric acid solution (6 mL)
Anode electrolytic solution bath 115: 0.02 mol/L aqueous sulfuric acid solution (6 mL)
Dilute aqueous sulfuric acid solution bath 125 for ammonia collection: 0.02 mol/L aqueous sulfuric acid solution (10 mL)
Measurement condition: constant potential measurement was performed at −2.3 V.

Ammonia was quantified with Thermo Scientific Dionex Ion Chromatography (IC) System, Dionex Integrion available from Thermo. The amount of ammonia produced was determined by quantifying the amount of ammonia contained in the aqueous sulfuric acid solution of the dilute aqueous sulfuric acid solution bath 125 for ammonia collection and in the aqueous sulfuric acid solution of the cathode electrolytic solution bath 105. The amount of ammonia produced per complex in the catalyst body was defined as “catalyst turnover number” and calculated by the following formula. The amount of electricity used was determined from the data of Versa STAT4 (power source apparatus 101), to thereby calculate the conversion efficiency.

Catalyst turnover number (mol/mol)=[amount of ammonia produced (μmol)/complex (μmol)] (mol/mol)

The results of the present Example are shown in Table 1 below.

TABLE 1

| | Amount of | Catalyst | Amount of | |
|---|---|---|---|---|
| Reaction | ammonia | turnover | electricity | Conversion |
| time | produced | number | used | efficiency |
| (hr) | (μmol) | (mol/mol) | (C) | (%) |
| 1 | 0.22 | 0.7 | 41.0 | 0.15 |
| 2 | 0.55 | 1.7 | 82.4 | 0.19 |
| 3 | 0.84 | 2.5 | 122.0 | 0.20 |

### Example 2

The ammonia electrolyzer (No. 1) was assembled in the same manner as in Example 1 described above, except that the solvent of catalyst ink B was changed from dichloromethane to 1-butyl-3-methylimidazolium bis(trifluoromethanesulfonyl)imide (i.e., ionic liquid), and application of the catalyst ink was not followed by drying in the formation of the cathode catalyst layer 103. Specifically, 5.8 mg (6.6 μmol) of the molybdenum complex of Formula (A1-1) was dissolved in 1.0 mL of 1-butyl-3-methylimidazolium bis(trifluoromethanesulfonyl)imide (i.e., ionic liquid), and the resultant solution was used as catalyst ink C. Thereafter, 50 μL of catalyst ink C was applied to the gas diffusion electrode 133 “GDE-Cathode-0,” to thereby form a gas diffusion electrode 133 “GDE-Cathode-2” containing 7.3 mg of the applied platinum catalyst serving as a solid catalyst, 0.33 μmol of the applied molybdenum complex of Formula (A1-1), and 50 μL of applied 1-butyl-3-methylimidazolium bis(trifluoromethanesulfonyl)imide.

Subsequently, in the assembly of the electrolyzer, a membrane electrode assembly was formed in the same manner as in the electrolyzer (No. 1) described above, except that the gas diffusion electrode as the cathode catalyst layer was replaced with the “GDE-Cathode-2.” The electrolyzer (No. 1) was assembled with use of the membrane electrode assembly including the gas diffusion electrode 133 “GDE-Cathode-2” as the cathode catalyst layer and the gas diffusion electrode 133 “GDE-Anode-0” as the anode catalyst layer. Ammonia was produced by electrolysis with the resultant electrolyzer in the same manner as in Example 1. The results of the present Example are shown in Table 2 below.

TABLE 2

| | Amount of | Catalyst | Amount of | |
|---|---|---|---|---|
| Reaction | ammonia | turnover | electricity | Conversion |
| time | produced | number | used | efficiency |
| (hr) | (μmol) | (mol/mol) | (C) | (%) |
| 1 | 1.34 | 4.1 | 47.4 | 0.82 |
| 2 | 1.83 | 5.6 | 66.9 | 0.79 |
| 3 | 1.98 | 6.0 | 84.2 | 0.68 |
| 6 | 2.35 | 7.1 | 183.2 | 0.37 |

### Example 3

The ammonia electrolyzer (No. 1) was assembled in the same manner as in Example 2 described above, except that the amount of catalyst ink A applied was changed in the formation of the cathode catalyst layer 103. The amount of catalyst ink A applied was controlled so that the gas diffusion electrode 133 as the cathode catalyst layer 103 was formed as a square (2.7×2.7 cm²) gas diffusion electrode 133 “GDE-Cathode-3A” containing 1.4 mg of the applied platinum catalyst. Thereafter, 50 μL of catalyst ink C was applied to the gas diffusion electrode 133 “GDE-Cathode-3A,” to thereby form a gas diffusion electrode 133 “GDE-Cathode-3” containing 1.4 mg of the applied platinum catalyst serving as a solid catalyst, 0.33 μmol of the applied molybdenum complex of Formula (A1-1), and 50 μL of applied 1-butyl-3-methylimidazolium bis(trifluoromethanesulfonyl)imide.

Subsequently, in the assembly of the electrolyzer, a membrane electrode assembly was formed in the same manner as in the electrolyzer (No. 1) described above, except that the gas diffusion electrode as the cathode catalyst layer was replaced with the “GDE-Cathode-3.” The electrolyzer (No. 1) was assembled with use of the membrane electrode assembly including the gas diffusion electrode 133 “GDE-Cathode-3” as the cathode catalyst layer and the gas diffusion electrode 133 “GDE-Anode-0” as the anode catalyst layer. Ammonia was produced by electrolysis with the resultant electrolyzer in the same manner as in Example 1. The results of the present Example are shown in Table 3 below.

TABLE 3

| | Amount of | Catalyst | Amount of | |
|---|---|---|---|---|
| Reaction | ammonia | turnover | electricity | Conversion |
| time | produced | number | used | efficiency |
| (hr) | (μmol) | (mol/mol) | (C) | (%) |
| 1 | 0.84 | 2.5 | 64.0 | 0.37 |
| 2 | 1.22 | 3.7 | 83.9 | 0.42 |
| 3 | 1.34 | 4.1 | 100.8 | 0.39 |

### Comparative Example 1

The ammonia electrolyzer (No. 1) was assembled in the same manner as in Example 1 described above, except that the carbon black-supported platinum catalyst (i.e., solid catalyst) was not used in the cathode catalyst layer 103. The cathode catalyst layer 103 was formed by applying 50 μL of catalyst ink B to carbon paper (trade name “TGP-H-060H” available from Toray Industries, Inc.) having a size of 2.7×2.7 cm². Specifically, the electrolyzer (No. 1) was assembled with use of the gas diffusion electrode 133 containing only 0.33 μmol of the applied molybdenum complex of Formula (A1-1) and not containing the platinum catalyst (i.e., solid catalyst). Ammonia was produced by electrolysis with the resultant electrolyzer in the same manner as in Example 1. The results of the present Example are shown in Table 4 below.

TABLE 4

| | Amount of | Catalyst | Amount of | |
|---|---|---|---|---|
| Reaction | ammonia | turnover | electricity | Conversion |
| time | produced | number | used | efficiency |
| (hr) | (μmol) | (mol/mol) | (C) | (%) |
| 1 | 0.20 | 0.6 | 105.1 | 0.06 |
| 2 | 0.25 | 0.8 | 163.8 | 0.05 |
| 3 | 0.30 | 0.9 | 228.8 | 0.04 |

### Comparative Example 2

The ammonia electrolyzer (No. 1) was assembled in the same manner as in Example 1 described above, except that the molybdenum complex was not used in the cathode catalyst layer 103. The aforementioned “GDE-Cathode-0” (application of only catalyst ink A without application of catalyst ink B) was used as the cathode catalyst layer. Specifically, the electrolyzer (No. 1) was assembled with use of the gas diffusion electrode 133 containing 7.3 mg of the applied platinum catalyst serving as a solid catalyst. Ammonia was produced by electrolysis with the resultant electrolyzer in the same manner as in Example 1. The results of the present Example are shown in Table 5 below.

TABLE 5

| | Amount of | Amount of | |
|---|---|---|---|
| Reaction | ammonia | electricity | Conversion |
| time | produced | used | efficiency |
| (hr) | (μmol) | (C) | (%) |
| 1 | 0.10 | 13.2 | 0.22 |

### Comparative Example 3

The ammonia electrolyzer (No. 1) was assembled in the same manner as in Example 1 described above, except that neither the carbon black-supported platinum catalyst (i.e., solid catalyst) nor the molybdenum complex was used in the cathode catalyst layer 103. Specifically, the electrolyzer (No. 1) was assembled with use of carbon paper (trade name “TGP-H-060H” available from Toray Industries, Inc.) as is as the cathode catalyst layer. Ammonia was produced by electrolysis with the resultant electrolyzer in the same manner as in Example 1. The results of the present Example are shown in Table 6 below.

TABLE 6

| | Amount of | Amount of | |
|---|---|---|---|
| Reaction | ammonia | electricity | Conversion |
| time | produced | used | efficiency |
| (hr) | (μmol) | (C) | (%) |
| 1 | 0.06 | 82.3 | 0.02 |

[Discussion]

Table 7 shows the results of Examples 1 to 3 and the results of Comparative Examples 1 to 3 (blank test).

TABLE 7

| | | | | Comparative | Comparative | Comparative |
|---|---|---|---|---|---|---|
| Item | Example 1 | Example 2 | Example 3 | Example 1 | Example 2 | Example 3 |
| Molybdenum complex [μmol] | 0.33 | 0.33 | 0.33 | 0.33 | — | — |
| Solid catalyst [mg] | 7.3 | 7.3 | 1.4 | — | 7.3 | — |
| Ionic liquid [μL] | — | 50 | 50 | — | — | — |
| Amount of NH₃ produced [μmol] | 0.22 (1 hr) | 1.34 (1 hr) | 0.84 (1 hr) | 0.20 (1 hr) | 0.10 (1 hr) | 0.06 (1 hr) |
| (Reaction time [hr]) | 0.55 (2 hr) | 1.83 (2 hr) | 1.22 (2 hr) | 0.25 (2 hr) | | |
| | 0.84 (3 hr) | 1.98 (3 hr) | 1.34 (3 hr) | 0.30 (3 hr) | | |
| | | 2.35 (6 hr) | | | | |
| Catalyst turnover number: | 0.7 (1 hr) | 4.1 (1 hr) | 2.5 (1 hr) | 0.6 (1 hr) | — | — |
| NH₃/molybdenum complex | 1.7 (2 hr) | 5.6 (2 hr) | 3.7 (2 hr) | 0.8 (2 hr) | | |
| [(mol/mol)] | 2.5 (3 hr) | 6.0 (3 hr) | 4.1 (3 hr) | 0.9 (3 hr) | | |
| (Reaction time [hr]) | | 7.1 (6 hr) | | | | |

According to the comparison between Example 1 and Comparative Example 1 (wherein only the complex was used in the catalyst), when the reaction time was one hour, the amount of ammonia produced in Example 1 was comparable to that in Comparative Example 1, whereas when the reaction time was three hours, the amount of ammonia produced in Example 1 was 2.8 times greater than that in Comparative Example 1, and an increase in amount of ammonia produced (from two hours to three hours of the reaction time) was 800% relative to the amount of ammonia produced in Comparative Example 1 (taken as 100%). These results indicate that the use of a catalyst system containing a combination of a complex and a solid catalyst leads to an increase in the amount of ammonia produced.

According to the comparison between Example 2 and Comparative Example 1 (wherein only the complex was used in the catalyst), when the reaction time was one hour, the amount of ammonia produced in Example 2 was 6.8 times greater than that in Comparative Example 1, whereas when the reaction time was three hours, the amount of ammonia produced in Example 1 was 6.7 times greater than that in Comparative Example 1, and an increase in amount of ammonia produced (from two hours to three hours of the reaction time) was 400% relative to the amount of ammonia produced in Comparative Example 1 (taken as 100%).

According to the comparison between Example 3 and Comparative Example 1 (wherein only the complex was used in the catalyst), when the reaction time was one hour, the amount of ammonia produced in Example 3 was 4.2 times greater than that in Comparative Example 1, whereas when the reaction time was three hours, the amount of ammonia produced in Example 1 was 4.6 times greater than that in Comparative Example 1, and an increase in amount of ammonia produced (from two hours to three hours of the reaction time) was 400% relative to the amount of ammonia produced in Comparative Example 1 (taken as 100%). These results indicate that the use of a catalyst system containing a combination of a complex and a solid catalyst and also containing an ionic liquid leads to an increase in the amount of ammonia produced.

### Example 4

In the formation of the cathode catalyst layer, the same experimental operation as in Example 2 described above was performed, except for adding a gold catalyst as a solid catalyst. Specifically, 2.5 mg (0.014 μmol) of 3-mercaptopropylmethyldimethoxysilane was added to a mixture prepared by suspension of 1.4 mg of gold foil (thickness: 0.025 mm, available from Alfa Aesar) in 200 μL of tetrahydrofuran, and the resultant mixture was irradiated with ultrasonic waves for five minutes with an ultrasonic cleaner ASU-6 (oscillation power: set at High), to thereby prepare catalyst ink E. This catalyst ink contains a gold catalyst produced by reaction between gold and 3-mercaptopropylmethyldimethoxysilane. The entire amount of catalyst ink E was applied to the aforementioned “GDE-Cathode-0,” and the tetrahydrofuran solvent was dried. This process was performed four times to thereby form “GDE-Cathode-4A.”

Subsequently, catalyst ink C was prepared by dissolving 5.8 mg (6.6 μmol) of the molybdenum complex of Formula (A1-1) in 1.0 mL of 1-butyl-3-methylimidazolium bis(trifluoromethanesulfonyl)imide (i.e., ionic liquid). Thereafter, 50 μL of catalyst ink C was applied to the aforementioned “GDE-Cathode-4A,” to thereby form a gas diffusion electrode “GDE-Cathode-4” containing 7.3 mg of the applied platinum catalyst serving as a solid catalyst, the applied gold catalyst produced by reaction between 1.4 mg of gold and 3-mercaptopropylmethyldimethoxysilane, 0.33 μmol of the applied molybdenum complex of Formula (A1-1), and 50 μL of applied 1-butyl-3-methylimidazolium bis(trifluoromethanesulfonyl)imide. The electrolyzer (No. 1) was assembled with use of the resultant electrode.

Subsequently, in the assembly of the electrolyzer, a membrane electrode assembly was formed in the same manner as in the electrolyzer (No. 1) described above, except that the gas diffusion electrode as the cathode catalyst layer was replaced with the “GDE-Cathode-4.” The electrolyzer (No. 1) was assembled with use of the membrane electrode assembly including the gas diffusion electrode 133 “GDE-Cathode-4” as the cathode catalyst layer and the gas diffusion electrode 133 “GDE-Anode-0” as the anode catalyst layer. Ammonia was produced by electrolysis with the resultant electrolyzer in the same manner as in Example 1. The results of the present Example are shown in Table 8 below.

TABLE 8

| | Amount of ammonia | Catalyst turnover |
|---|---|---|
| Reaction time | produced | number |
| (hr) | (μmol) | (mol/mol) |
| 1 | 1.44 | 4.4 |
| 2 | 1.99 | 6.0 |

### INDUSTRIAL APPLICABILITY

The present invention is applicable to an ammonia production method.

### DESCRIPTION OF THE REFERENCE NUMERALS

100: ammonia electrolyzer (No. 1)
101: power source apparatus
102: electrolyte membrane
103: cathode catalyst layer (catalyst layer for ammonia production)
104: cathode collector
105: cathode electrolytic solution bath
106: cathode electrolytic solution
108: cathode (cathode catalyst layer and cathode collector)
113: anode catalyst layer
114: anode collector
115: anode electrolytic solution bath
116: anode electrolytic solution
117: metal plate electrode
118: anode (anode catalyst layer and anode collector, or metal plate electrode)
121: pipe
122: nitrogen cylinder
123: nitrogen cylinder regulator
124: nitrogen gas mass flow controller
125: dilute aqueous sulfuric acid solution bath for ammonia collection
126: draft apparatus
131: membrane electrode assembly
132: cathode membrane electrode assembly
133: gas diffusion electrode
141: electrolysis cell
200: ammonia electrolyzer (No. 2)
300: ammonia electrolyzer (No. 3)
400: ammonia electrolyzer (No. 4)

1. An ammonia production method comprising supplying electrons from a power source, protons from a proton source, and nitrogen molecules from nitrogen gas supply means in the presence of a complex and a solid catalyst at a cathode in a production apparatus performing electrolysis, thereby producing ammonia from nitrogen molecules, wherein the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain);
the solid catalyst is a metal catalyst, an oxide catalyst, or a combination of these; and
the proton source is an electrolyte membrane, an electrolytic solution, or both the electrolyte membrane and the electrolytic solution.

2. The ammonia production method according to claim 1, wherein the molybdenum complex (A) is a molybdenum complex of the following Formula (A1), (A2), or (A3): 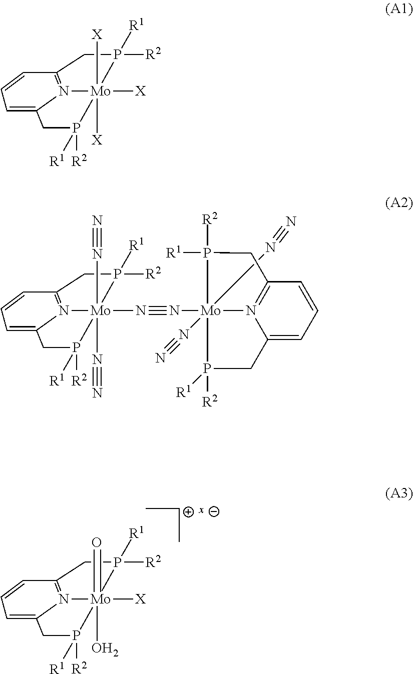
(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

3. The ammonia production method according to claim 1, wherein the molybdenum complex (B) is a molybdenum complex of the following Formula (B1) or (B2): 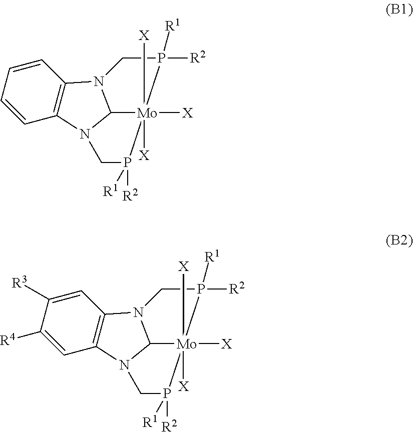
(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

4. The ammonia production method according to claim 1, wherein the molybdenum complex (C) is a molybdenum complex of the following Formula (C1): 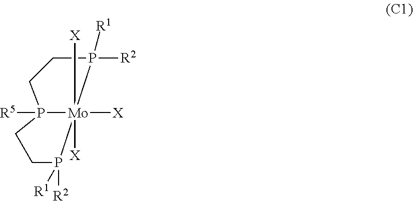
(wherein R¹ and R² are alkyl groups that are possibly identical to or different from each other; R⁵ is an aryl group; and X is an iodine atom, a bromine atom, or a chlorine atom).

5. The ammonia production method according to claim 1, wherein the molybdenum complex (D) is a molybdenum complex of the following Formula (D1) or (D2): 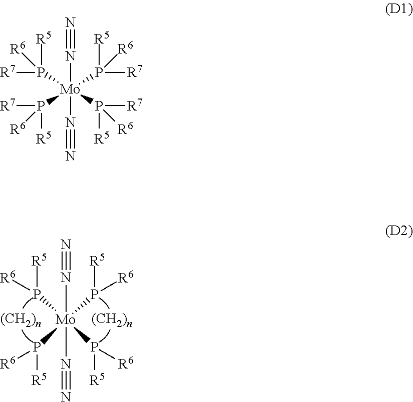
(wherein R⁵ and R⁶ are aryl groups that are possibly identical to or different from each other; R⁷ is an alkyl group; and n is 2 or 3).

6. The ammonia production method according to claim 1, wherein the solid catalyst contains platinum, gold, palladium, or zinc oxide.

7. A membrane electrode assembly comprising a cathode catalyst layer, an anode catalyst layer, and an electrolyte membrane sandwiched between the layers and bonded thereto, wherein
the cathode catalyst layer contains a complex and a cathode solid catalyst;
the anode catalyst layer contains an anode solid catalyst;
the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); and
each of the cathode solid catalyst and the anode solid catalyst is a metal catalyst, an oxide catalyst, or a combination of these.

8. The membrane electrode assembly according to claim 7, wherein the molybdenum complex (A) is a molybdenum complex of the following Formula (A1), (A2), or (A3): 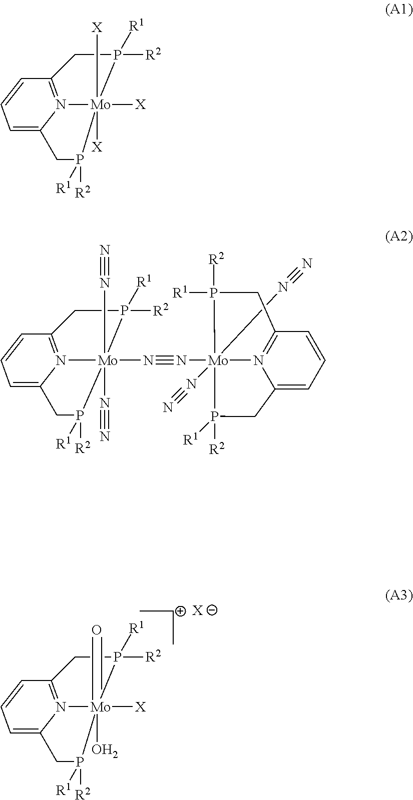
(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

9. The membrane electrode assembly according to claim 7, wherein the molybdenum complex (B) is a molybdenum complex of the following Formula (B1) or (B2): 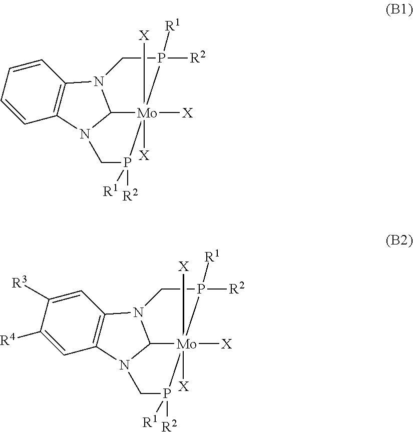
(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

10. The membrane electrode assembly according to claim 7, wherein the molybdenum complex (C) is a molybdenum complex of the following Formula (C1): 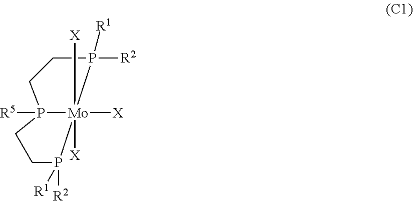
(wherein R¹ and R² are alkyl groups that are possibly identical to or different from each other; R⁵ is an aryl group; and X is an iodine atom, a bromine atom, or a chlorine atom).

11. The membrane electrode assembly according to claim 7, wherein the molybdenum complex (D) is a molybdenum complex of the following Formula (D1) or (D2): 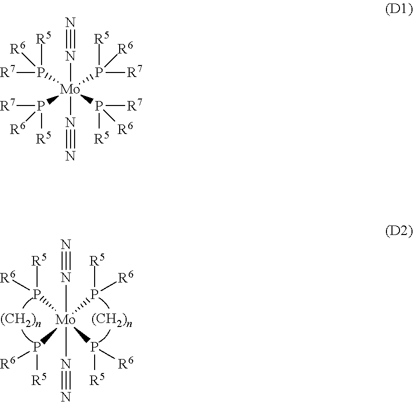
(wherein R⁵ and R⁶ are aryl groups that are possibly identical to or different from each other; R⁷ is an alkyl group; and n is 2 or 3).

12. The membrane electrode assembly according to claim 7, wherein the cathode solid catalyst contains platinum, gold, palladium, or zinc oxide.

13. An ammonia production apparatus for producing ammonia from nitrogen molecules by electrolysis, the apparatus comprising the membrane electrode assembly according to claim 7 comprising a cathode catalyst layer, an electrolyte membrane, and an anode catalyst layer; a cathode including the cathode catalyst layer bonded to one side of the electrolyte membrane, and a cathode collector disposed outside of the cathode catalyst layer; and an anode including the anode catalyst layer bonded to the other side of the electrolyte membrane, and an anode collector disposed outside of the anode catalyst layer, wherein
the cathode includes the cathode catalyst layer and the cathode collector;
the anode includes the anode catalyst layer and the anode collector;
the apparatus comprises a bath of a cathode electrolytic solution which is in liquid contact with the cathode, a bath of an anode electrolytic solution which is in liquid contact with the anode, a power source for supplying electrons to the cathode, a proton source for supplying protons to the cathode, and means for supplying nitrogen gas to the cathode electrolytic solution or the cathode; and
the proton source is the electrolyte membrane, the anode electrolytic solution, or both the electrolyte membrane and the anode electrolytic solution.

14. An ammonia production apparatus for producing ammonia from nitrogen molecules by electrolysis, the apparatus comprising the membrane electrode assembly according to claim 7 comprising a cathode catalyst layer, an electrolyte membrane, and an anode catalyst layer; a cathode including the cathode catalyst layer bonded to one side of the electrolyte membrane, and a cathode collector disposed outside of the cathode catalyst layer; and an anode including the anode catalyst layer bonded to the other side of the electrolyte membrane, and an anode collector disposed outside of the anode catalyst layer, wherein
the cathode includes the cathode catalyst layer and the cathode collector;
the anode includes the anode catalyst layer and the anode collector;
the apparatus comprises an anode electrolytic solution bath containing an anode electrolytic solution which is in liquid contact with the anode of the membrane electrode assembly, a power source for supplying electrons to the cathode, a proton source for supplying protons to the cathode, and means for supplying nitrogen gas to the cathode; and
the proton source is the electrolyte membrane, the electrolytic solution, or both the electrolyte membrane and the electrolytic solution.

15. A gas diffusion electrode comprising a complex and a cathode solid catalyst, wherein the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); and
the cathode solid catalyst is a metal catalyst, an oxide catalyst, or a combination of these.

16. The gas diffusion electrode according to claim 15, wherein the molybdenum complex (A) is a molybdenum complex of the following Formula (A1), (A2), or (A3): 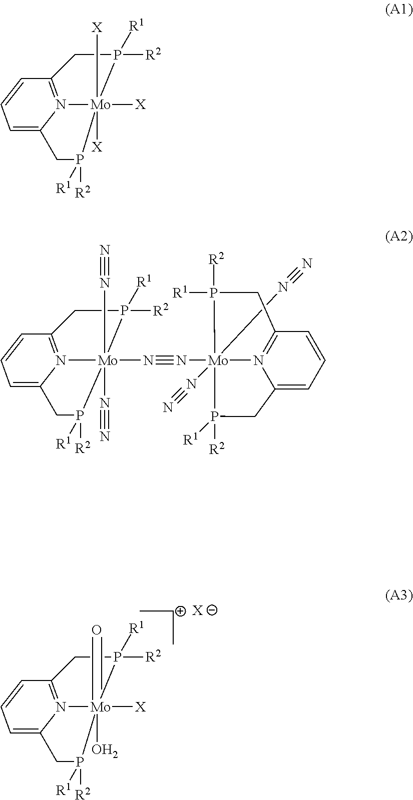
(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

17. The gas diffusion electrode according to claim 15, wherein the molybdenum complex (B) is a molybdenum complex of the following Formula (B1) or (B2): 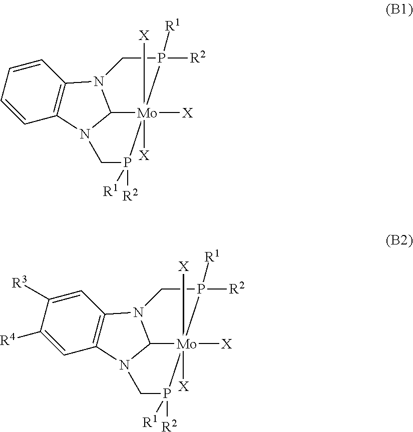
(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

18. The gas diffusion electrode according to claim 15, wherein the molybdenum complex (C) is a molybdenum complex of the following Formula (C1): 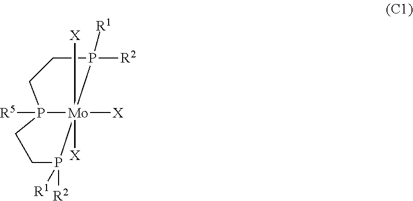
(wherein R¹ and R² are alkyl groups that are possibly identical to or different from each other; R⁵ is an aryl group; and X is an iodine atom, a bromine atom, or a chlorine atom).

19. The gas diffusion electrode according to claim 15, wherein the molybdenum complex (D) is a molybdenum complex of the following Formula (D1) or (D2): 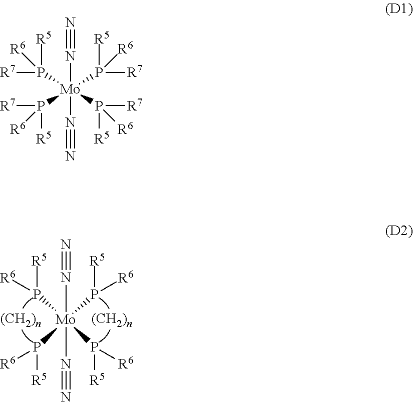
(wherein R⁵ and R⁶ are aryl groups that are possibly identical to or different from each other; R⁷ is an alkyl group; and n is 2 or 3).

20. The gas diffusion electrode according to claim 15, wherein the cathode solid catalyst contains platinum, gold, palladium, or zinc oxide.

21. An ammonia production apparatus for producing ammonia from nitrogen molecules by electrolysis, the apparatus comprising the gas diffusion electrode according to claim 15, the gas diffusion electrode being a cathode catalyst layer;
a cathode collector disposed on one side of the cathode catalyst layer being the gas diffusion electrode;
a bath of an electrolytic solution which is in liquid contact with the cathode catalyst layer;
a cathode including the cathode catalyst layer and the cathode collector;
an anode formed of a metal plate electrode;
a power source for supplying electrons to the cathode;
a proton source for supplying protons to the cathode; and
means for supplying nitrogen gas to the electrolytic solution or the cathode, wherein the proton source is the electrolytic solution.

22. A cathode membrane electrode assembly comprising an electrolyte membrane and a cathode catalyst layer bonded to one side of the electrolyte membrane, wherein
the cathode catalyst layer contains a complex and a cathode solid catalyst;
the complex is:
(A) a molybdenum complex having, as a PNP ligand, 2,6-bis(dialkylphosphinomethyl)pyridine (wherein the two alkyl groups are possibly identical to or different from each other, and at least one hydrogen atom of the pyridine ring is substitutable with an alkyl group, an alkoxy group, or a halogen atom);
(B) a molybdenum complex having, as a PCP ligand, N,N-bis(dialkylphosphinomethyl)dihydrobenzimidazolidene (wherein the two alkyl groups are possibly identical to or different from each other, and at least one hydrogen atom of the benzene ring is substitutable with an alkyl group, an alkoxy group, or a halogen atom);
(C) a molybdenum complex having, as a PPP ligand, bis(dialkylphosphinoethyl)arylphosphine (wherein the two alkyl groups are possibly identical to or different from each other); or
(D) a molybdenum complex of trans-Mo(N₂)₂(R⁵R⁶R⁷P)₄ (wherein R⁵ and R⁶ are aryl groups that are possibly identical to or different from each other; R⁷ is an alkyl group; and two R⁷s are possibly connected together to form an alkylene chain); and
the cathode solid catalyst is a metal catalyst, an oxide catalyst, or a combination of these.

23. The cathode membrane electrode assembly according to claim 22, wherein the molybdenum complex (A) is a molybdenum complex of the following Formula (A1), (A2), or (A3): 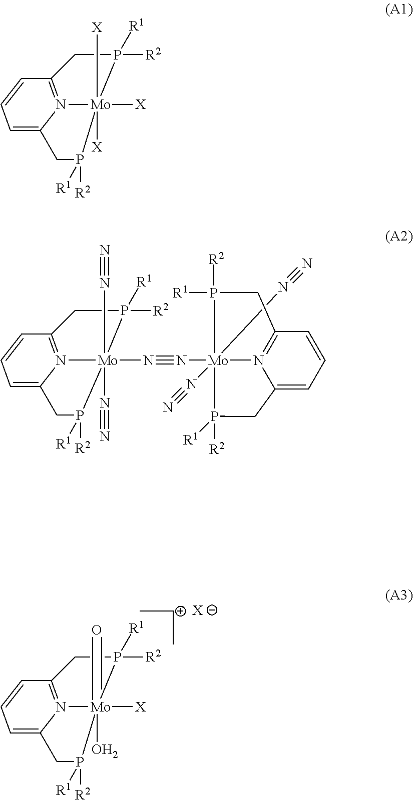
(wherein R¹ and R² are alkyl groups that are possibly identical to or different from each other; X is an iodine atom, a bromine atom, or a chlorine atom; and at least one hydrogen atom on the pyridine ring is substitutable with an alkyl group, an alkoxy group, or a halogen atom).

24. The cathode membrane electrode assembly according to claim 22, wherein the molybdenum complex (B) is a molybdenum complex of the following Formula (B1) or (B2): 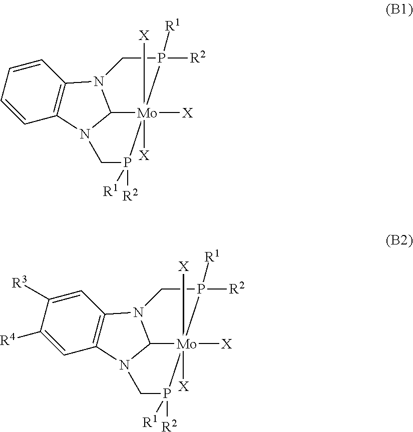
(wherein R¹ and R² are alkyl groups that are possibly identical to or different from each other; X is an iodine atom, a bromine atom, or a chlorine atom; at least one hydrogen atom on the benzene ring is substitutable with an alkyl group, an alkoxy group, or a halogen atom; and at least one of R³ and R⁴ is substituted with a trifluoromethyl group).

25. The cathode membrane electrode assembly according to claim 22, wherein the molybdenum complex (C) is a molybdenum complex of the following Formula (C1): 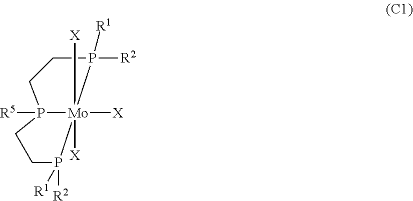
(wherein R¹ and R² are alkyl groups that are possibly identical to or different from each other; R⁵ is an aryl group; and X is an iodine atom, a bromine atom, or a chlorine atom).

26. The cathode membrane electrode assembly according to claim 22, wherein the molybdenum complex (D) is a molybdenum complex of the following Formula (D1) or (D2): 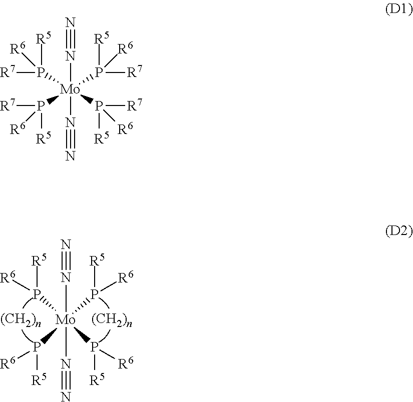
(wherein R⁵ and R⁶ are aryl groups that are possibly identical to or different from each other; R⁷ is an alkyl group; and n is 2 or 3).

27. The cathode membrane electrode assembly according to claim 22, wherein the cathode solid catalyst contains platinum, gold, palladium, or zinc oxide.

28. An ammonia production apparatus for producing ammonia from nitrogen molecules by electrolysis, the apparatus comprising the cathode membrane electrode assembly according to claim 22 comprising an electrolyte membrane and a cathode catalyst layer bonded to one side of the electrolyte membrane;
a cathode collector disposed on a side of the cathode catalyst layer opposite the electrolyte membrane;
a cathode including the cathode catalyst layer and the cathode collector;
a bath of an electrolytic solution which is in liquid contact with the electrolyte membrane;
an anode formed of a metal plate electrode;
a power source for supplying electrons to the cathode;
a proton source for supplying protons to the cathode; and
means for supplying nitrogen gas to the electrolytic solution or the cathode, wherein the proton source is the electrolyte membrane, the electrolytic solution, or both the electrolyte membrane and the electrolytic solution.
